(19) United States
(12) Patent Application Publication
(10) Pub. No.: US 2003/0004815 A1
(43) Pub. Date: Jan. 2, 2003

(54) Business procedure and business operation/management apparatus

(75) Inventors: Satoshi Sakai, Newport Coast, CA (US); Soji Ishida, Buena Park, CA (US)

Correspondence Address: KODA & ANDROLIA, Suite 3850, 2029 Century Park East, Los Angeles, CA, 90067-3024, US

(73) Assignee: ORBIT TECHNOLOGY CORPORATION

(21) Appl. No.: 09/888,996

(22) Filed: Jun. 22, 2001

(51) Int. Cl. G06F 17/60

(52) U.S. Cl. 705/26

(57) ABSTRACT

The problem is to provide a business method and business operation/management apparatus intended to promote merchandise sales through an increase in the customer attraction and enhanced appeal of the gift-forwarding service by allowing the customer to exchange or deposit the value of (receive credit for) the received gift merchandise. The solution includes a means of accepting an order through the Internet for the simple purchase and delivery of merchandise, for the purchase of merchandise as a gift not accompanied by an option to select, or for the purchase and delivery of merchandise as a gift accompanied by an option to select; a means of making an unconditional delivery upon acceptance of an order, either for the simple purchase and delivery of merchandise or for the purchase and delivery of merchandise as a gift not accompanied by an option to select, in which the necessary data is processed to deliver to the recipient the merchandise, as designated by the orderer, without granting the recipient an option to select; a means of informing the recipient of the contents of the gift, upon acceptance of an order for the purchase and delivery of merchandise as a gift accompanied by an option to select, in which the recipient is informed, through the Internet, of the contents of the gift as originally ordered; a means of querying the selection, whereby the intent of the recipient relative to the offer of the gift is queried through the Internet, in the form of giving to the recipient a choice between the “take” and “credit” relative to the gift as originally offered; and a means of responding to and processing a selection, where upon selection of “take” by the recipient, the necessary data is processed to deliver the merchandise designated as a gift by the orderer; or upon selection of “credit” by the recipient, the necessary data is processed to post a credit to the account of the recipient according to the price of the merchandise designated as a gift by the orderer; wherein the credit posted to the account of the recipient may be applied to all or part of the amount of an order, either for the simple purchase and delivery of merchandise or for the purchase and delivery of merchandise as a gift not accompanied by an option to select.

### BACKGROUND OF THE INVENTION

1. Technical Field of the Invention

This invention concerns a business procedure and business operation/management apparatus, specifically the business procedure and business operation/management apparatus as intended to promote merchandise sales through an increase in the customer attraction and enhanced appeal of the gift-forwarding service by allowing the customer to exchange or deposit the value of the credit for the received gift merchandise.

2. Prior Art

The business procedure in which merchandise sales is promoted through a gift-forwarding service has been extensively used at a gift comer of a department store or a supermarket, or at various gift shops operating as independent brokers. Especially in recent years various virtual gift shops have been established on the Internet and readily utilized by younger people as one of various means of exchanging gifts between lovers and friends. A customer of this type of virtual gift shop initially selects gift merchandise from a predistributed catalog, a shopping mall on the Internet or the like. The customer then orders a gift from the forwarding service by following a required procedure in the home page of the virtual gift shop.

Generally, the information relative to the sender of the gift (name, address, contact telephone number, credit card number and the like), the information relative to the recipient of the gift (name, address, contact telephone number and the like) and the information relative to the gift merchandise (name, model and other merchandise identification, price and the like) are verified at the time the order is placed, and the payment for the gift-forwarding service is settled through a credit card or other means.

Upon acceptance of an order for a gift-forwarding service, the gift shop places an order with the outlet store of the merchandise designated by the sender. The sender-designated gift merchandise is delivered by a prescribed delivery service to the recipient designated by the sender. The gift shop in this case performs merchandise sales brokerage, operating between the customer and outlet store.

When the conventional merchandise sales broker sells through a gift-forwarding service, the gift merchandise delivered to the recipient may be an item that is unsatisfactory to the recipient or may be a duplicate of merchandise already owned, since the delivery is unconditionally made following the acceptance of a gift-forwarding order. It would be impolite to return the gift to the sender, or it might be cumbersome to exchange the gift for other merchandise at an outlet or specialty store. The general level of proceeds from selling to a specialized buyer is often relatively low. As is demonstrated in the foregoing, the conventional merchandise sales broker that sells through the gift-forwarding service does not necessarily satisfy the user adequately. Consequently, the number of participating sales outlets or dealers is small. It has been pointed out that the lack of satisfaction can result in a limited range of merchandise selections and associated weak customer appeal.

### SUMMARY OF THE INVENTION

This invention was created in light of the aforementioned problems regarding the conventional gift-forwarding service. The purpose of the invention is to provide a business procedure and business operation/management apparatus intended to promote merchandise sales through an increase in customer attraction and enhanced appeal of the gift-forwarding service by allowing the customer to exchange or deposit the value of the credit for the received gift merchandise.

In order to accomplish the aforementioned purposes of the invention, the business procedure of the invention comprises: a step of accepting an order either for the simple purchase and delivery of merchandise, for the purchase of merchandise as a gift not accompanied by an option to select, or for the purchase and delivery of merchandise as a gift accompanied by an option to select, a step of making an unconditional delivery upon acceptance of an order either for the simple purchase and delivery of merchandise or for the purchase and delivery of merchandise as a gift not accompanied by an option to select, in which the necessary arrangements are made for the unconditional delivery of the merchandise, as designated by the orderer, without granting the recipient an option to select, a step of granting the recipient an option to select upon acceptance of an order for the purchase and delivery of merchandise as a gift accompanied by an option to select, in which the designated recipient is informed of the contents of the gift and is granted an option of selecting from a set of choices, including “take” and “credit”, and a step of responding to a selection by the recipient, whereby if the recipient selects the “take,” the necessary arrangements are made to deliver to the recipient the merchandise designated by the orderer as a gift, or if the recipient selects the “credit,” a credit is posted to the account of the recipient, in accordance with the price of the merchandise designated by the orderer as a gift. The credit posted to the account of the recipient may be applied to all or part of the amount of an order, either for the simple purchase and delivery of merchandise or for the purchase and delivery of merchandise as a gift not accompanied by an option to select.

The term “gift accompanied by an option to select” in the foregoing refers to a form of gift that grants the recipient, as designated by the sender, a choice between “taking” the gift merchandise designated by the sender and an alternate offer of another service according to the value of the gift merchandise. This embodiment includes at least one alternate choice—the “credit”—beside the “take.”The term “simple purchase and delivery of merchandise” refers to a form of delivery whereby the merchandise designated by the orderer is delivered to the recipient designated by the orderer. No alternative, such as in the case of the procedure for the “gift accompanied by an option to select,” is allowed. The term “purchase and delivery of merchandise as a gift not accompanied by an option to select” refers to a special form of the “purchase and delivery of merchandise as a gift accompanied by an option to select,” in which no choice is granted the recipient. Unlike the procedure for the “simple purchase and delivery of merchandise,” it is a form of gift in which the procedure for the “purchase and delivery of merchandise as a gift not accompanied by an option to select” calls for arrangements to deliver the designated merchandise to the recipient without waiting for the recipient to make a choice, whereas in the procedure for the “purchase and delivery of merchandise accompanied by an option to select,” arrangements to deliver the designated merchandise is initiated only after the recipient responds or selects.

Although the term “delivery” is used, this business procedure does not necessarily involve the actual delivery of merchandise. A form of business offered may be complete with the delivery of merchandise, or it may leave the delivery to a separate business operation. The form of business here includes at least “making arrangements to deliver the merchandise designated by the orderer as a gift.” A service may be included in the “merchandise” available for purchase and delivery on order. A room-cleaning service or other manual service may be desirable as an example of the merchandise available for selection.

A “credit” refers to the account receivable, credit, deposit or other form of credit. An example would be a form of deposit in which the merchandise is converted into money or the like and deposited according to the value of the merchandise designated by the orderer. Consequently, the posted “amount” of credit may vary according to the form of credit. Credit as described here is the “credit posted to the account of the recipient that may be applied to all or part of the amount of an order, either for the simple purchase and delivery of merchandise or for the purchase and delivery of merchandise as a gift not accompanied by an option to select.” The procedures “an order for the simple purchase and delivery of merchandise” and “an order for the purchase and delivery of merchandise as a gift not accompanied by an option to select” are not necessarily mutually exclusive. In fact, they may be used simultaneously.

It would be preferable to provide “credit” service in a form that can be expressed in numerical values to facilitate identifications by the customer. In this case an even more preferable form would be to use “1” to represent an amount of 1.00 yen (or 1.00 dollar depending on the currency of the country) in indicating the balance of credit, thereby eliminating the feeling of “loss” that the recipient might have through the use of the “credit” service. The credit being posted to the account of the recipient as “according to the price of the merchandise,” the posted amount of credit need not be equal to the value of the merchandise originally designated as a gift. The amount of credit to be posted may be higher or lower than the value of the designated gift merchandise, depending on the circumstances. Given that the credit posted to the account of the recipient “may be applied to all or part of the amount of an order,” credit may be applied to part of the amount, and cash, for instance, may be used for the balance of a new order of the purchase and delivery of merchandise. Other methods besides cash—for instance, a debit card, credit card or note—may be used. The use of other methods to supplement the available credit allows the ordering of the purchase and delivery of merchandise whose value would be beyond the amount of available credit.

The aforementioned form allows the recipient to “establish an amount of credit” according to the price of the sender-designated gift merchandise in lieu of taking the same, and to use the credit to purchase the desired merchandise. In the embodiment the sender is able to inform the recipient of the merchandise that the sender desires to give to the recipient. The recipient, on the other hand, is able to receive the desired merchandise, by selecting the “credit” option, within the prescribed range of merchandise as an alternative to the sender-designated gift merchandise, without ever attempting to return or resell the merchandise to a specialized buyer, even if the delivered merchandise is unsatisfactory to the recipient or is a duplicate of merchandise already owned.

The second embodiment of this invention is a business procedure, comprising: a step of accepting an order for the purchase and delivery of merchandise as a gift accompanied by an option to select, a step of granting the recipient an option to select upon acceptance of an order for the purchase and delivery of merchandise as a gift accompanied by an option to select, in which the designated recipient is informed of the contents of the gift and is granted an option of selecting from a set of choices, including “take” and “credit”, and a step of responding to a selection by the recipient. Whereby, if the recipient selects the “take,” the necessary arrangements are made to deliver to the recipient the merchandise designated by the orderer as a gift, or if the recipient selects the “credit,” a credit is posted to the account of the recipient in accordance with the price of the merchandise designated by the orderer as a gift and the credit posted to the account of the recipient may be applied to all or part of the amount of an order for the purchase and delivery of merchandise as a gift accompanied by an option to select.

Explanations for the terms “the order for the purchase and delivery of merchandise as a gift accompanied by an option to select,” “merchandise,” “delivery,” “credit and “may be applicable to all or part of the price of an order” are omitted, since they are nearly identical to those given in the first embodiment.

The aforementioned form allows the recipient to establish an amount of credit according to the price of the sender-designated gift merchandise in lieu of taking the same, and to use the credit to order a new gift. The recipient is further able to use the credit to purchase the desired merchandise by designating himself/herself as the recipient. In this embodiment the sender is able to inform the recipient of the merchandise that the sender desires to give the recipient, while the recipient is able to effectively use the sender-designated gift merchandise by selecting the “credit” option, without ever attempting to return or resell the merchandise to a specialized buyer, even if the delivered merchandise is unsatisfactory to the recipient or is a duplicate of merchandise already owned.

As shown in the first embodiment, the second embodiment may include: a step of accepting an order either for the simple purchase and delivery of merchandise or for the purchase of merchandise as a gift not accompanied by an option to select and the credit posted to the account of the recipient may be applied to all or part of the amount of an order, either for the simple purchase and delivery of merchandise or for the purchase and delivery of merchandise as a gift not accompanied by an option to select. This embodiment will certainly enhance the customer appeal of the credit system.

The third embodiment of this invention is a business procedure, comprising: a step of accepting an order for the purchase and delivery of merchandise as a gift accompanied by an option to select, a step of granting the recipient an option to select upon acceptance of an order for the purchase and delivery of merchandise as a gift accompanied by an option to select, in which the designated recipient is informed of the contents of the gift and is granted an option of selecting from a set of choices, including “take” and “exchange”, and a step of responding to a selection by the recipient. In this embodiment, if the recipient selects the “take,” the necessary arrangements are made to deliver to the recipient the merchandise designated by the orderer as a gift; or if the recipient selects the “exchange,” the merchandise designated as a gift by the orderer is replaced by the merchandise designated by the recipient and the necessary arrangements are made for the delivery thereof to the recipient. The merchandise available for “exchange” may be made selectable using the total of a group of gift merchandise for an alternate piece of merchandise or one piece of gift merchandise for an alternate group of merchandise. The unused balance resulting from an exchange to cheaper alternate merchandise may be deposited. The selectable range of alternate merchandise may be deliberately limited to a price range according to the price of the original gift merchandise. Here the term “exchange” refers to the service of enabling the recipient to select and receive merchandise as an alternative to the merchandise originally designated by the sender. The “credit” service described previously may also be interpreted as a variation of “exchange” from a broader perspective. However, here the “exchange” should be interpreted as a “direct exchange from specific merchandise to other merchandise.”

Explanations for the terms “gift accompanied by an option to select,” “merchandise” and “delivery” are omitted, since they are nearly identical to those given in the first and second embodiments.

The aforementioned form allows the sender to inform the recipient of the merchandise that the sender desires to give to the recipient. It also allows the recipient to receive the desired merchandise within the prescribed range of merchandise selection by selecting the “exchange” option even if the delivered merchandise is unsatisfactory to the recipient or is a duplicate of merchandise already owned.

The third embodiment may be used in combination with the first and second embodiments explained previously. A combination, for instance, would allow the deposit of an unused balance resulting from an exchange of merchandise, thereby enhancing the convenience offered by “exchange” and “credit” services for the customer.

It would be preferable that a broker, operating between the customer and one or a plurality of dealers, implements the business procedure revealed in the first, second and third embodiments, and the broker earns a brokerage fee. Apparently, in the foregoing instance the brokerage fee is paid to the broker, commonly by, but not necessarily limited to, the dealer or customer. The payment of a fee in a business of this type is not necessarily identifiable with a specific profit or receipt of payment as the mutual accounts between the parties are usually settled, for instance, by the month. Accordingly, the receipt of a brokerage fee is broadly described as being “earned” with no limitation as to the method, source or timing of the receipt thereof. Therefore, the fee may not necessarily be limited to the “brokerage fee” only, except that the fee, being a profit earned by the broker from a “fee,” shall refer to the earnings from the individual or organization that benefits from the business. The aforementioned form allows the broker to earn a profit from the fee, enabling the establishment of the brokerage as an independent business entity.

It is preferable in the first and second embodiments that the potential dealer of the merchandise scheduled for purchase, from whom no purchase of the scheduled merchandise is actually made whenever the recipient selects “credit,” be paid a nomination fee according to the scheduled selling price of the merchandise. In the embodiment the presence or absence of a broker is not a prerequisite. The embodiment is applicable where the business itself is, for instance, jointly operated by a plurality of dealers, without a broker. Although the term “be paid” is used here, the payment of a fee in a business of this type is not necessarily identifiable with a specific profit or receipt of payment as the mutual accounts between the parties are usually settled, for instance, by the month, as described previously. The nomination fee, for example, may be directly allocated out of the receipt from the customer or paid through a sponsor by appointing one for the business. Therefore, the payer and timing of the payment of the nomination fee are not defined here. Thus the fee may not necessarily be limited to the “nomination fee” only. It is also possible not to pay the fee to the “potential dealer of the merchandise scheduled for purchase, from whom no purchase is actually made” if the dealer of the merchandise designated by the orderer is the same as the dealer of the merchandise newly designated by the recipient.

In this embodiment the terms “scheduled for purchase,” “potential dealer of the merchandise” and “scheduled selling price” are used because the recipient's acceptance of a gift will not be definite until the recipient selects “take,” but the embodiment is not necessarily limited to a form using these terms. The aforementioned form allows the dealer of the merchandise to earn a prescribed profit, even where the merchandise is designated as a gift by the sender but not taken by the recipient, such that the form urges merchandise dealers to participate in the business of this invention, thereby leading to the proliferation of the business.

In the first and second embodiments a system may be established such that the acceptance of an order for a gift accompanied by an option to select will deliver cash and/or credit in the amount of the purchase price of a gift merchandise to the broker; a certain amount according to the cash paid in by the orderer is allocated to the fee for the broker, whether or not the recipient selects “credit”; and in a case where the recipient selects “credit” a certain amount according to the selling price of the gift merchandise is allocated to the fee for the dealer who missed the actual sale of the gift merchandise, and the purchase price of the gift merchandise is posted as credit to the recipient's account. The term “cash” as used here shall not limit the receipt to a direct receipt in cash. For instance, the payment by a credit card or debit card is included in the term “cash.” The payment of fees is simply described as “is allocated” because, as explained previously, the payment of a fee in a business of this type is not necessarily identifiable with a specific profit or receipt of payment as the mutual accounts between the parties are usually settled, for instance, by the month. Therefore, the mode and timing of the payment of fees are not defined here. The term “is allocated” shall include the case of these fees being allocated in effect out of the receipts by the broker of the payment from the orderer.

As the term “purchase price of a gift merchandise” implies, the amount to be paid for the purchase of a gift merchandise may include certain fees in addition to the selling price of the gift merchandise. In this form of order the amount of credit that would be posted to the recipient's account is in accordance only with the “selling price of the merchandise” if the amount of an order for a gift includes any type of fee. The event “the recipient selects the ‘credit’” may be substituted by “the recipient selects the gift merchandise regardless of the manner of selection thereof.” In this form, the selection of the “credit” by the recipient yields a difference between the credit owned by the recipient (apparent credit amount) and the amount deposited with the broker. In this embodiment the difference is adjusted by reducing the credit by the amount of a credit-service fee, or by collecting cash. The term “the amount deposited with the broker” refers to the balance (actual credit amount) of the paid purchase price of a gift less the aforementioned brokerage fee, the aforementioned nomination fee and the amount payable to the dealer as the sales amount thereof. The term “the difference is adjusted” doesn't necessarily mean that the difference is to be reduced to zero. All of the business procedures incorporating various forms described may be implemented through the use of a business operation/management apparatus.

The business procedure described in the first embodiment as presented previously may be implemented as the fourth embodiment of this invention. The fourth embodiment of this invention is a business operation/management apparatus, comprising: a means of accepting an order through the Internet for the simple purchase and delivery of merchandise, for the purchase of merchandise as a gift not accompanied by an option to select, or for the purchase and delivery of merchandise as a gift accompanied by an option to select, a means of making an unconditional delivery upon acceptance of an order, either for the simple purchase and delivery of merchandise or for the purchase and delivery of merchandise as a gift not accompanied by an option to select, in which the necessary data is processed to deliver to the recipient the merchandise, as designated by the orderer, without granting the recipient an option to select, a means of informing the recipient of the contents of the gift, upon acceptance of an order for the purchase and delivery of merchandise as a gift accompanied by an option to select, in which the recipient is informed, through the Internet, of the contents of the gift as originally ordered, a means of querying the selection, whereby the intent of the recipient relative to the offer of the gift is queried through the Internet, in the form of giving to the recipient a choice between the “take” and “credit” relative to the gift as originally offered; and a means of responding to and processing a selection, where upon selection of “take” by the recipient, the necessary data is processed to deliver the merchandise designated as a gift by the orderer, or upon selection of “credit” by the recipient, the necessary data is processed to post a credit to the account of the recipient according to the price of the merchandise designated as a gift by the orderer, wherein the credit posted to the account of the recipient may be applied to all or part of the amount of an order, either for the simple purchase and delivery of merchandise or for the purchase and delivery of merchandise as a gift not accompanied by an option to select.

The business procedure described in the second embodiment is implemented as the fifth embodiment of this invention. The fifth embodiment of this invention shall be a business operation/management apparatus, comprising: a means of accepting orders through the Internet for the purchase and delivery of certain merchandise as a gift accompanied by an option to select, a means of informing the recipient of the contents of the gift, where upon receipt of an order for the purchase and delivery of merchandise as a gift accompanied by an option to select, the recipient is informed, through the Internet, of the contents of the gift as originally ordered, a means of querying the selection, whereby the intent of the recipient relative to the gift as originally offered is queried, through the Internet, in the form of giving the recipient a choice between “take” and “credit”, and a means of responding to and processing a selection, where upon selection of “take” by the recipient the necessary data is processed to deliver the merchandise designated as a gift by the orderer, or upon selection of “credit” by the recipient the necessary data is processed to post a credit to the account of the orderer in accordance with the price of the gift designated by the orderer, wherein the credit posted to the account of the recipient may be applied to all or part of the amount of an order for the purchase and delivery of merchandise as a gift accompanied by an option to select.

The business procedure described in the third embodiment is implemented as the sixth embodiment of this invention. The sixth embodiment of this invention shall be a business operation/management apparatus, comprising: a means of accepting orders whereby an order is accepted through the Internet for the purchase and delivery of certain merchandise as a gift accompanied by an option to select, a means of informing the recipient of the contents of the gift, where upon receipt of an order for the purchase and delivery of certain merchandise as a gift accompanied by an option to select the recipient of the gift is informed, through the Internet, of the contents of the gift as originally ordered, a means of querying the selection, whereby the intent of the recipient relative to the gift as originally offered is queried, through the Internet, in the form of giving the recipient a choice between “take” and “exchange”; and a means of responding to and processing a selection, where upon selection of “take” by the recipient the necessary data is processed to deliver the merchandise designated as a gift by the orderer, or upon selection of “exchange” by the recipient the necessary data is processed to post a credit to the account of the orderer in accordance with the price of the gift designated by the orderer. Needless to say, it is possible to implement the fourth through sixth embodiments through various combinations thereof.

It is preferable that the means of accepting orders in the business operation/management apparatus described in the fourth through sixth embodiments is a means of accepting orders through the Internet. The acceptance of orders through the Internet would enable implementation of the required processing relative to an order for the purchase and delivery of merchandise, presenting the merchandise for sale, selection of merchandise by the customer and like processes, all on one screen via the World Wide Web. It would be even more preferable that the website for the acceptance of orders as gifts include one or a plurality of virtual outlet stores. The term “virtual outlet store” refers to a virtual store that is implemented through a web page. A website in this form would enable the user to select gift merchandise through the Internet, feeling as if he or she is shopping in a conventional manner, and additionally to enjoy this mode of shopping. Other preferable forms include a website for the acceptance of orders as gifts in which the website links to one or a plurality of websites. This form of website allows the user to, for instance, first select merchandise for purchase (as a gift) from among the merchandise presented on the site furnished by the dealer, and then to move to a separate site, furnished through the business procedure of this invention, where the user could execute the necessary steps to purchase the merchandise. This form allows the required steps of the business procedure of this invention to be distributed to different sites, thereby facilitating the accommodation of the new participating dealers into the business using the business procedure of this invention.

It is preferable that the means of informing the contents of a gift in the business operation/management apparatus in the fourth through sixth embodiments informs the recipients of the contents of gifts by sending e-mail including the link information necessary to connect to the virtual outlet stores dealing in such gift merchandise.

An example of “link information” would be the URLs for the websites of virtual outlet stores. The form involving link information allows the recipient through e-mail to know that there is a gift ordered on the recipient's behalf. Further, the link allows the recipient to investigate the details of the gift merchandise with reference to the display of the gift merchandise through the Web screen. It would also be possible to attach images of the gift merchandise to the mail. As has been demonstrated, the business operation/management apparatus of this invention implements the business procedure of this invention utilizing the Internet. The apparatus enables the user (customer) to readily enjoy various advantages of the business procedure of this invention by simply operating a personal computer at home, thereby promoting an increase in the number of users. The business operation/management apparatus may also undertake cumbersome tasks of the sales operations of the brokers and dealers, reducing the operating costs associated with such tasks.

### BRIEF DESCRIPTION OF THE DRAWINGS

The above mentioned feature and objects will become more apparent from the following description taken in accompaniment with the following figures where like numerals represent like elements and in which:

FIG. 1 shows a summary configuration of the business procedure of the invention;

FIG. 2 shows a summary of the overall process in the business procedure of the invention;

FIGS. 3A, 3B and 3C show various operating modes for the business procedure of the invention;

FIG. 4 shows examples of fees established for different operating modes;

FIG. 5 is a flowchart showing the settlement process for a gift order (No. 1);

FIG. 6 is a flowchart showing the settlement process for a gift order (No. 2);

FIG. 7 is a flowchart showing the settlement process on the purchase of merchandise;

FIG. 8 shows the equations for calculating the credit-service fee;

FIG. 9 is a flowchart showing a summary of the overall process by the business operation/management apparatus;

FIG. 10 is a flowchart showing a summary of the gift-request process;

FIG. 11 is a flowchart showing the details of the gift-request acceptance process;

FIG. 12 is a flowchart showing the details of the gift e-mail creation process;

FIG. 13 is a flowchart showing the details of the gift e-mail transmission process;

FIG. 14 is a flowchart showing the response-acceptance process;

FIG. 15 is a flowchart showing the details of the delivery-request process;

FIG. 16 is a flowchart showing the details of the exchange-request process;

FIG. 17 is a flowchart showing the details of the credit-request process;

FIG. 18 is a flowchart showing the details of the merchandise-purchase request process;

FIG. 19 shows an example of the web page for selecting a dealer (virtual outlet store);

FIG. 20 shows an example of the web page for selecting merchandise;

FIG. 21 shows an example of the gift-order web page;

FIG. 22 shows an example of the web page for the settlement of a gift order;

FIG. 23 shows an example of the gift e-mail;

FIG. 24 shows an example of the web page to be transmitted to the recipient in the response-acceptance process;

FIG. 25 shows an example of the web page to be displayed at the purchaser's end during the merchandise-purchase request process;

FIG. 26 shows an example of the web page for settlement of an ordinary merchandise purchase;

FIG. 27 shows the contents of the different areas of memory;

FIG. 28 shows the contents of the merchandise data file;

FIG. 29 shows the contents of the broker memory area;

FIG. 30 shows the contents of the member file;

FIG. 31 shows the contents of the dealer area of memory;

FIG. 32 shows a summary configuration of the business procedure of the invention using the Internet; and

FIGS. 33(a) and 33(b) show the concept of links between the customer and the broker and/or dealers.

### DETAILED DESCRIPTION OF THE INVENTION

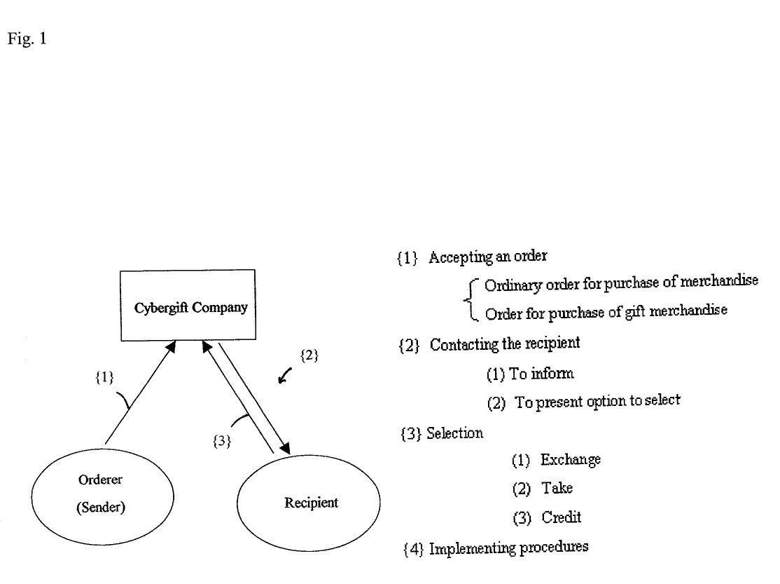

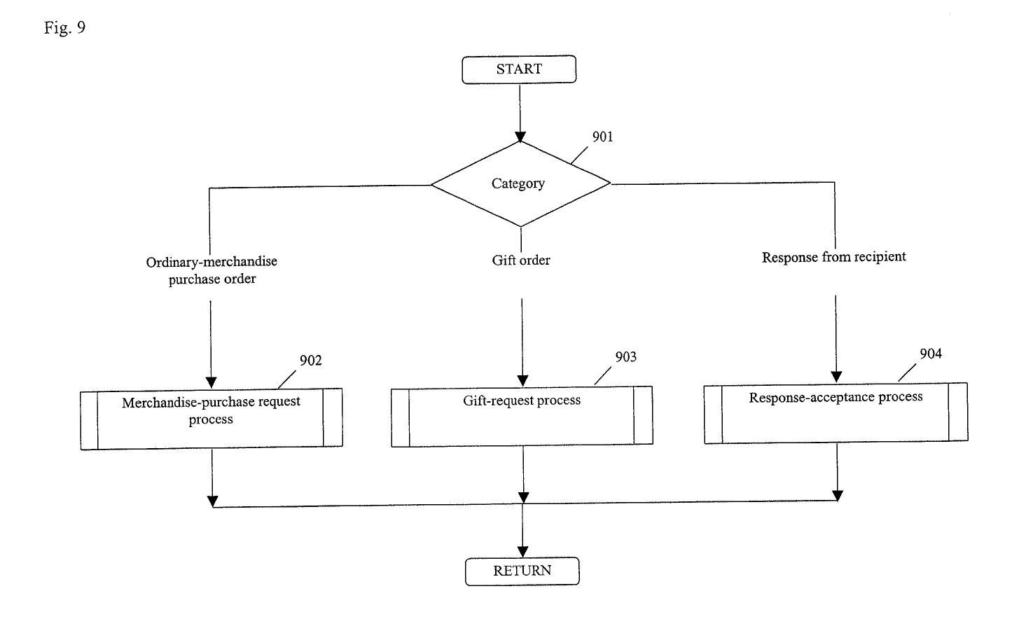

One preferred embodiment of the invention is explained below, as accompanied by the reference figures. The first preferred embodiment of the invention will be revealed in detail by explaining the embodiment with reference to FIGS. 1 through 8. Then, a business operation/management apparatus will be explained with reference to FIGS. 9 through 33 as a means of implementing the business procedure of the invention.

FIG. 1 shows a summary configuration of the business procedure of the invention. In this example the operating body of a service offered through use of the invention shall be called “Cybergift Company” for the purpose of the explanation. As shown in FIG. 1, upon acceptance {1} of an order from customer A for the purchase of merchandise as a gift, Cybergift Company at {2}: (1) informs the recipient B of the contents of the gift (sender, contents of the merchandise and the like); and (2) presents an option of selecting from the “take” of gift merchandise, “credit” in lieu of taking the gift merchandise, or “exchange” of the gift merchandise for the desired merchandise. Subsequently, Cybergift Company at {3} accepts the response (selection) thereto from the recipient B out of the choices given the recipient, and at {4} implements various procedures according to the response.

The “take” response literally refers to recipient's taking the delivery of the merchandise as designated by the sender. The “credit” response refers to the saving of the sender-designated merchandise as a credit (hereinafter referred to as the “Cyber Credit”); in this case, in the recipient's individual account (a ledger, for instance) in an amount equal to the selling price of the merchandise. The Cyber Credit thus deposited may be applied to the amount of a new order by the recipient for the purchase of merchandise (including both the purchase of merchandise as a gift and the ordinary purchase of merchandise), which will be explained later, at the rate of one Japanese yen (or any other currency depending on the country) for one Cyber Credit unit (1 c.c.). The “exchange” response refers to the exchange of the merchandise designated by the sender for new merchandise designated by the recipient. In this instance, the sender-designated merchandise is allowed to be exchanged for merchandise of equal price. Cybergift Company will also accept an order for the ordinary purchase of merchandise (simple purchase and delivery) besides the purchase of merchandise as a gift. In this case the order is processed, upon acceptance thereof, to deliver the designated merchandise to the designated delivery destination without following steps {2} through {4}. Since the “delivery” may be allowed to take a variety of forms, including undertaking of the task thereof by an existing delivery service, no explanation will be especially given as to the form of delivery.

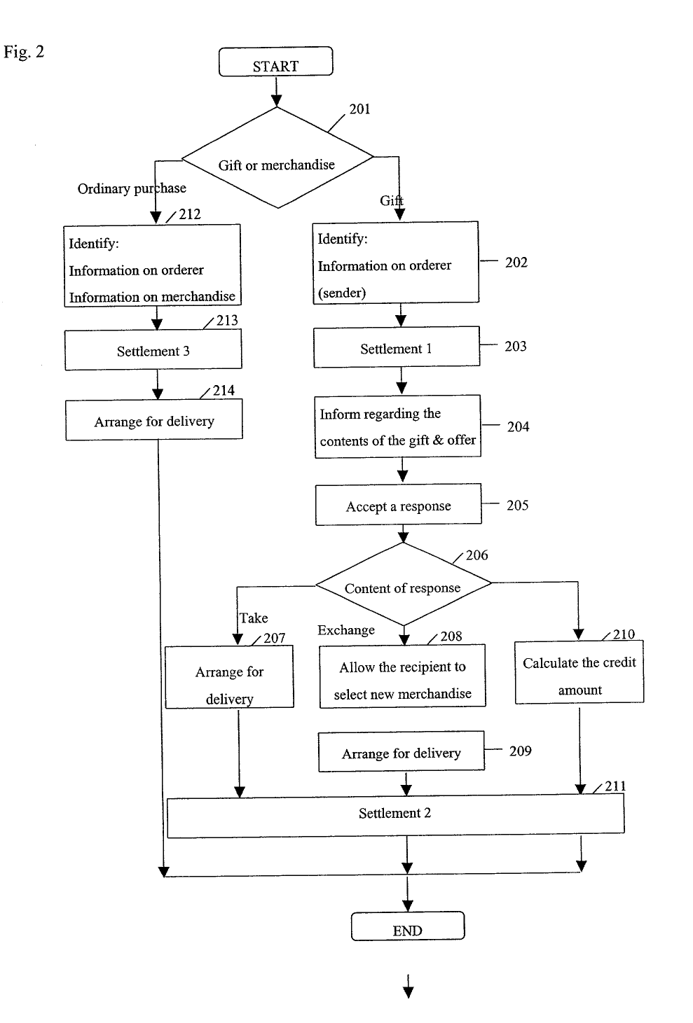

FIG. 2 is a flowchart showing the overall process in the business procedure of the invention. As shown in FIG. 2, Cybergift Company, upon acceptance of an order, determines whether the order is for an ordinary purchase of merchandise or the purchase of a gift (hereinafter referred to as a “gift order”).

If the accepted order is a gift order at step 201 (Gift), the information on the orderer (sender), gift merchandise and recipient is identified. Examples of the “information on the sender” include the sender's name, address, contract/telephone number and e-mail address. Examples of the “information on the recipient” include the recipient's name, address, contact/telephone number and e-mail address. Examples of the “information on the gift merchandise” include the product name, product number and quantity (number of pieces) of merchandise to be purchased. The sender selects the gift merchandise, for instance, out of a merchandise catalog or the like that is distributed to the sender in advance. When all information is identified at 202, settlement process 1 is implemented next at step 203. The settlement as processed here is for the payment of the purchase amount primarily relative to an order for a gift by a sender. The amount may be settled through actual payment (including payment by a credit card, for instance) or by Cyber Credit. Ledger entries and the like are also made relative to settlement at this time. An explanation of the contents and methods of ledger entries is omitted here. Reference may be made to a detailed explanation given later using examples of various ledgers in an application of the business operation/management apparatus.

When settlement process 1 is completed, the recipient is informed of the contents of the gift at 204, and is also informed simultaneously of three choices, namely the “take,” “exchange” and “credit” from which to select a desired response. When the response (selection) of the recipient is accepted at step 205, various processes shown below are implemented according to the selection returned.

If the accepted response is the “take” at step 206, the take process is implemented whereby the necessary arrangements are made to deliver the sender-designated merchandise to the recipient at step 207 according to the various information as identified in step 202. Next, settlement process 2 is implemented at step 211 upon confirmed selection of the “take.” Ledger entries as required for the confirmed “take” are also made at this time. An explanation of “ledger” is again omitted here. Reference may be made to a detailed explanation given later using examples thereof in an application of the business operation/management apparatus.

If the accepted response is the “exchange” at step 206, the exchange process is implemented whereby the recipient is allowed to select desired merchandise of a price equal to the selling price (or total price) of the gift merchandise at step 208 in this example. Next, the necessary arrangements are made to deliver to the recipient the merchandise newly designated by the recipient at step 209. Subsequently, settlement process 2 is implemented at step 211 upon confirmed selection of the “exchange.” Ledger entries as required for the confirmed “exchange” are also made at this time. An explanation of “ledger” is again omitted here. Reference may be made to a detailed explanation given later using examples thereof in an application of the business operation/management apparatus.

If the accepted response is the “credit” at step 206, the credit process is implemented whereby the amount of Cyber Credit equal to the selling price of the gift merchandise is calculated. In the settlement process 2 that follows, the calculated amount of Cyber Credit is saved or entered in the recipient's individual account or ledger. Other ledger entries as required for the confirmed “credit” are also made at this time. An explanation of “ledger” is again omitted here. Reference may be made to a detailed explanation given later using examples thereof in an application of the business operation/management apparatus. The same is applicable to an explanation of the contents and modes of the individual account for Cyber Credit.

If, on the other hand, the accepted order is for the ordinary purchase of merchandise at step 201, the information on the orderer, delivery destination, merchandise to be purchased and the like is identified at step 212. Examples of the “information on the orderer” include the orderer's name, address, contract address/telephone number and e-mail address. As for the “information on the delivery destination,” if the destination of merchandise delivery differs from the address of the purchaser or orderer, the address of the destination is additionally specified. Examples of the “information on the merchandise to be purchased” include the product name, product number and quantity (number of pieces) of merchandise to be purchased. When all information is identified, settlement process 3 is implemented next at step 213. The settlement as processed here is for the payment of the purchase amount primarily relative to an order for a gift by a purchaser. As is the case with an order for a gift, the amount may be settled through actual payment (including payment by a credit card, for instance) or by Cyber Credit. Ledger entries and the like are also made relative to settlement at this time. An explanation of the contents and methods of ledger entries is omitted here. Reference may be made to a detailed explanation given later using examples of various ledgers in an application of the business operation/management apparatus.

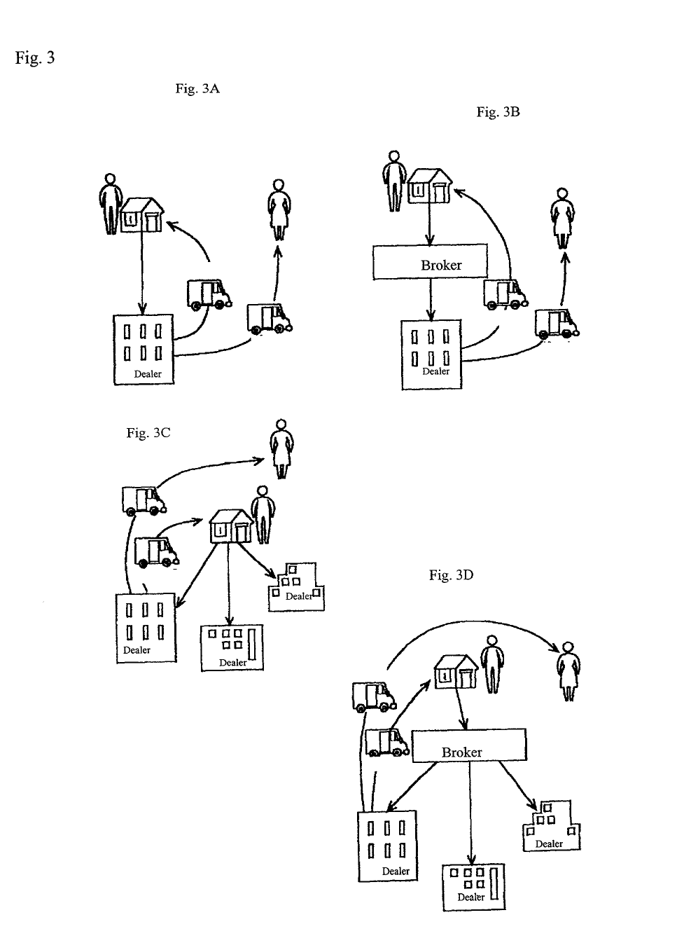

Various operating modes may be considered for Cybergift Company. FIG. 3 shows Cybergift Company operating in four different modes from the perspective of the operational autonomy and merchandise supplies. Mode A in FIG. 3 shows an operating mode in which a dealer solely operates Cybergift Company and furnishes merchandise. Mode B shows an operating mode in which a business (broker), positioned between the customer and the dealer, operates Cybergift Company, while a dealer solely furnishes merchandise. Mode C shows an operating mode in which a plurality of dealers jointly operate Cybergift Company and furnish merchandise. Mode D shows an operating mode in which a broker operates Cybergift Company, while a plurality of dealers furnish merchandise.

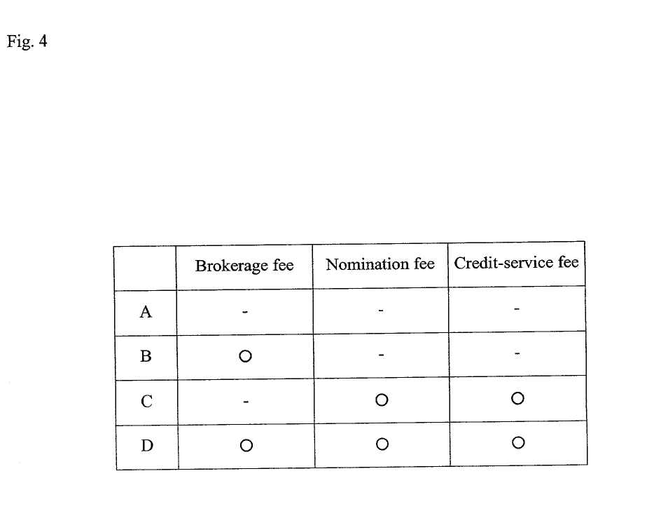

In the business procedure of the invention, various fees, along with simple profits from merchandise sales, may be established to give prescribed profits to the broker and dealers. FIG. 4 shows examples of suitable fees established for different operating modes in the form of a table. General explanations of the fees are provided below. The term “brokerage fee” refers to the profit for the broker. In this example, the brokerage fee is a fee allocated out of the amount received from the customer relative to the purchase of merchandise (the purchase of merchandise for a gift or ordinary merchandise purchase) and constitutes a portion of the sales amount of the dealer The establishment of this fee in the business procedure of the invention enables the establishment of a brokerage business as an independent business entity.

In the given example the “nomination fee” refers to the fee to be paid to the dealer of the particular merchandise as originally designated by a sender who orders a gift. In the form as implemented, the recipient is given choices in addition to “taking” the gift merchandise when an order for a gift is accepted from a sender. This may cause the original designation of certain merchandise of a dealer to ultimately become the sale of another dealer when there are a plurality of dealers within Cybergift Company. In such a case the nomination fee thus established provides a prescribed profit to the dealer whose merchandise is originally designated. The nomination fee in this example is allocated out of the amount received from the customer relative to the purchase of the gift merchandise.

In the form as implemented, the purchase of gift merchandise allows the recipient a choice of “credit” in addition to “taking” the merchandise, as previously explained. When the recipient selects “credit,” the sender-designated merchandise is saved in the recipient's individual account as Cyber Credit (in the unit of c.c.) in an amount equal to the selling price of the merchandise. If a brokerage fee and nomination fee are established, a portion of the amount received from the sender is allocated to these fees. This arrangement would result in a difference between the credit arising out of the amount received from a sender and the balance of the received amount after the various fees are deducted (more correctly, after an additional deduction due to a payment to the dealer). This would result, for example, in repeated payments of the nomination fee to the dealer in the absence of new receipts of payment if gift orders using Cyber Credit and the selection of “credit” by the recipients for gift merchandise purchased by Cyber Credit are repeated. To use an extreme example, a dealer sells 10,000 yen worth of merchandise but the broker may be left with an actual balance of only 1,000 yen. To eliminate this problem, a “credit-service fee” is created. The credit-service fee is imposed on the credit user according to the amount of Cyber Credit used to settle a gift order. The credit-service fee adjusts the difference between the real balance, being the fixed amount received minus various fees (primarily, the nomination fee) (hereinafter referred to as the balance of the received amount) and the value of merchandise purchasable with the balance of credit, such that the posting of a credit equal to the selling price of the gift merchandise would not cause a problem pointed out in the foregoing. The form of charging the credit-service fee will be explained in detail later in this document.

As seen from the foregoing, the action and effect of each fee is different. Consequently, a fee should be established in a form that is suitable to a particular operating mode of Cybergift Company, as shown in FIG. 4. The forms in which the fees are established herein are examples thereof and are not to limit the establishment of fees in those forms only. As shown in the figure, mode A calls for no fees because one dealer solely operates Cybergift Company and furnishes merchandise. In mode B the brokerage fee is established because a broker exists between the dealer and the customer. No nomination fee is established, since there is only one dealer involved. If the brokerage fee is collected only from the dealer who actually sells merchandise, there is no difference created between the balance of the received amount and the balance of credit, even if no credit-service fee is established. In mode C the nomination fee is established because there is a plurality of dealers. In the absence of brokers, no brokerage fee is established. The credit-service fee is established to adjust the difference between the actual balance of the received amount and the balance of credit resulting from the nomination-fee system. In mode D the brokerage fee, nomination fee and credit-service fee are established because of the presence of a broker and a plurality of dealers. The calculation or payment and collection of these fees are performed in the settlement processes (settlement processes 1 through 3) shown as steps 203, 211 and 213, respectively, in the flowchart of FIG. 2.

Details of settlement processes 1 through 3 follow. The embodiment used here is in mode D, as illustrated in FIG. 3. It should be easy for those skilled in the area to envision the settlement processes in modes A through C by referring to the embodiment in mode D. In settlement processes 1 through 3, ledger entries and the like are also performed. An explanation of ledger is again omitted here, since a detailed explanation will be given later using examples of various ledgers in an application of the business operation/management apparatus.

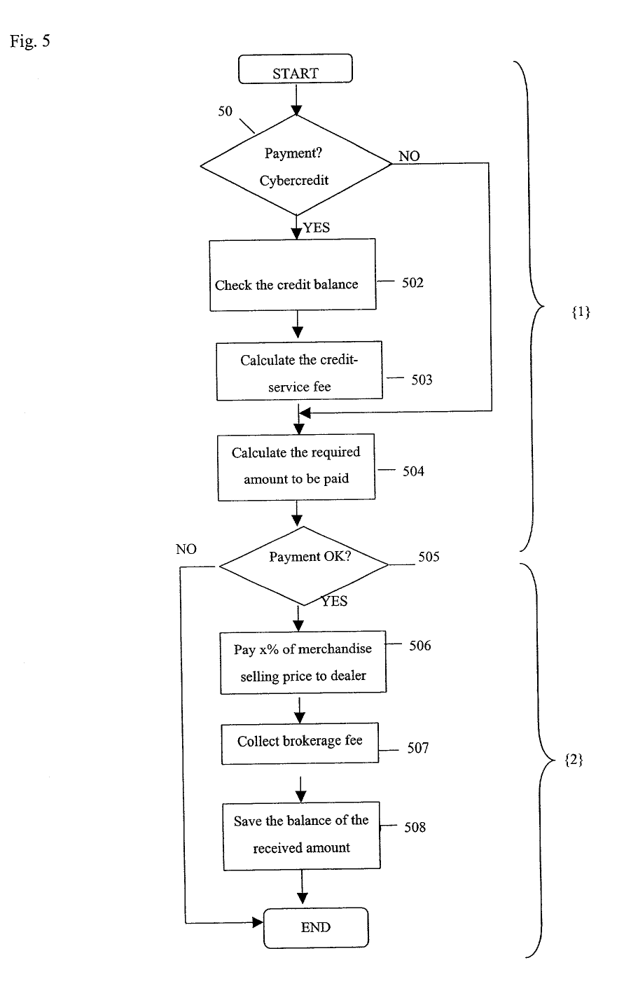

FIG. 5 shows a flowchart for settlement process 1 at step 213 at the time of a gift order. As shown in the figure, settlement process 1 includes: {1} the purchase-amount settlement process relative to a gift order (steps 501 through 505); and {2} the settlement process relative to the payment or collection of various fees (steps 506 through 508).

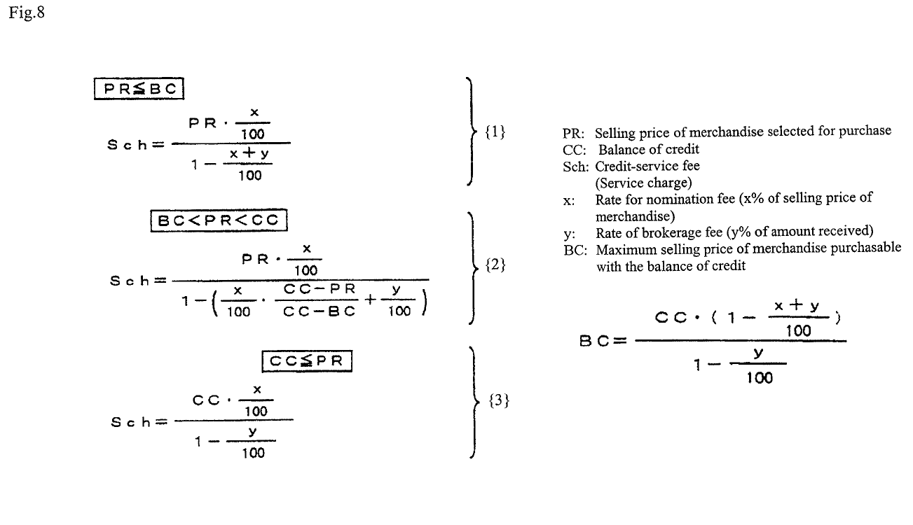

The purchase-amount settlement process {1} in FIG. 5 checks whether or not the sender is to use Cyber Credit for the payment at step 501. If no Cyber Credit is to be used (step 501, NO), the amount may be settled through actual payment (including payment by a credit card and the like) and the process calculates the amount to be paid equal to the selling price of the sender-specified gift merchandise at step 504. A first-time customer (with a zero credit balance) of Cybergift Company would necessarily select this method of settlement. If Cyber Credit is to be used (step 501, YES), the process checks the balance of Cyber Credit in the sender's individual account at step 502. The process then calculates or determines the credit-service fee at step 503 using prescribed equations shown in FIG. 8 and calculates the required amount to be paid additionally, if any at step 504. The process is terminated if the sender rejects the requirement for Cyber Credit and payment as presented (step 505, NO). If the sender approves the requirement (step 505, YES), the settlement process {2} is implemented relative to the payment or collection of various fees at steps 506 through 508.

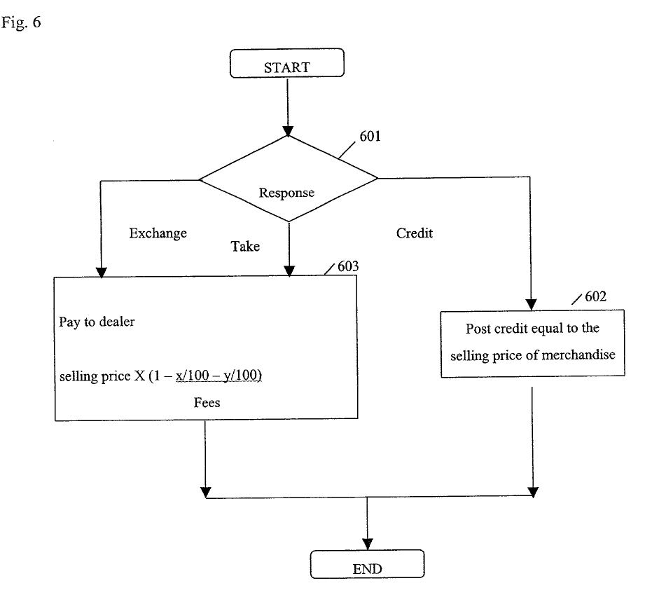

In step 506 the process posts or pays the nomination fee to the dealer's account in advance at x% of the selling price of the sender-designated merchandise. In step 507 the process posts or collects to the broker's account the brokerage fee at y% of the amount received from the sender out of the received amount. Next, the process saves the amount received from the sender, less these two fees, as the balance of the received amount at step 508. The process is now terminated. FIG. 6 shows a flowchart for settlement process {2}. The details of the process are different, depending on the selection of “take,” “exchange” or “credit” by the recipient. If the recipient selects the “credit” at step 601, the process saves Cyber Credit in the recipient's individual account in an amount equal to the selling price of the gift merchandise at step 602 and the process is terminated. If the recipient selects “take” or “exchange” at step 601, the amount calculated using the following equation is posted or paid to the account of the dealer (or, in the case of “exchange,” the particular dealer whose merchandise is newly selected by the recipient) at step 603, and the process is terminated:

Amount of payment=Selling price of merchandise X (1−x/100−y/100)

As seen above, the amount posted here is the selling price of the merchandise less the nomination fee already posted. This procedure effectively eliminates the payment of the nomination fee where the recipient selects “take” for the sender-designated merchandise. If, on the other hand, the recipient selects “exchange” for the merchandise, part of the sales amount of the dealer whose merchandise is newly selected by the recipient is, in effect, allocated to the nomination fee for the sender-designated dealer. As shown in the foregoing equation, the brokerage fee for the broker is allocated out of the sales of the dealer (the amount received from the customer).

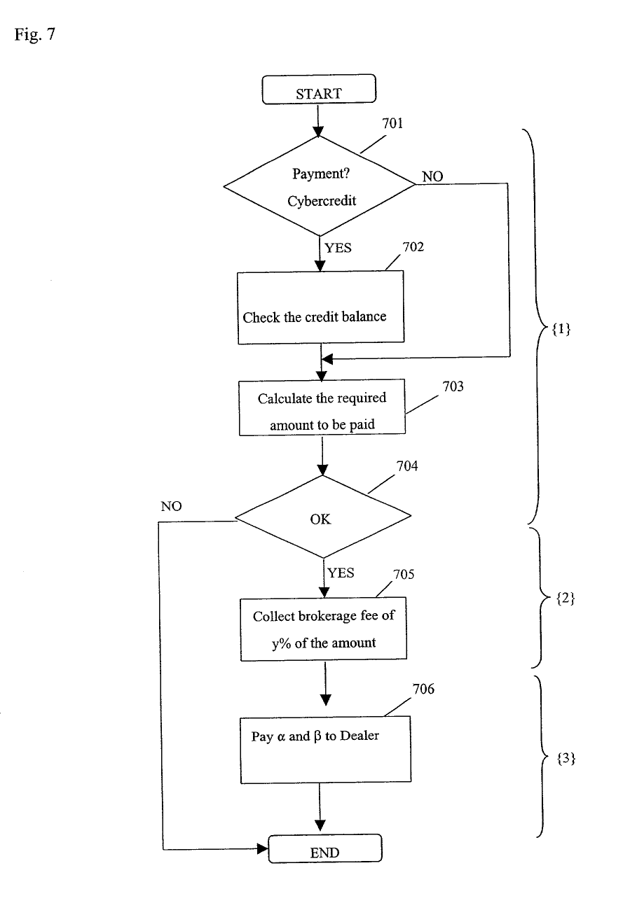

FIG. 7 shows the details of settlement process 3 implemented upon the ordinary purchase of merchandise. As shown in FIG. 7, in this example settlement process 3 includes {1} the purchase-amount settlement process relative to the ordinary purchase of merchandise at steps 701 through 704, the settlement process {2} relative to the collection of the fee at step 705 and the settlement process {3} relative to the payment from the broker to the dealer at step 706.

The purchase-amount settlement process {1} first checks whether or not the sender is to use Cyber Credit for the payment at step 701. If no Cyber Credit is to be used (step 701, NO), the amount may be settled through actual payment (including payment by a credit card and the like) and the process calculates the amount to be paid equal to the selling price of the sender-specified gift merchandise at step 703. If the credit is to be used (step 701, YES), the process checks the balance of the credit in the sender's individual account at step 702. If the balance of Cyber Credit is short of the purchase amount of the merchandise, the process calculates the difference as the required amount to be paid at step 703. As is evident here, no credit-service fee is charged in an ordinary merchandise purchase, allowing the customer to purchase merchandise equivalent to the balance of the credit.

If the sender rejects the requirements for Cyber Credit and payment as presented (step 704, NO), the process is terminated. If the sender approves the requirement (step 704, YES), the settlement process {2} is implemented relative to the collection of the brokerage fee, consisting of posting or collection to the broker's account the brokerage fee at y% of the amount received out of the received amount at step 705. Next, the settlement process {3} is implemented relative to the payment to the dealer, consisting of posting or payment to the dealer's account the following amount at step 706:

The amount to be posted=α+β

where

α=Amount of credit used X (1−x/100−y/100)

β=Amount received X (1−y/100)

As shown by “α,” the collection of the nomination fee (at x% of the selling price) and the brokerage fee (at y% of the amount received) creates a difference between the Cyber Credit amount posted to the recipient's account and the actual balance of the received amount. The amount “β” indicates the deduction of the brokerage fee at y% of the amount received.

FIG. 8 shows the equations used in step 503 in FIG. 5 (settlement process {1}) to calculate the credit-service fee. The equations are examples; they are not to limit the calculation of the credit-service fee thereto.

The term “Sch” in the figure refers to the credit-service fee, “PR” refers to the selling price of the merchandise, “CC” refers to the balance of the customer's Cyber Credit, “x” refers to the rate of the nomination fee (x% of the selling price of the merchandise) and “y” refers to the rate of the brokerage fee (y% of the amount received). In this example, the rates for the nomination fee and brokerage fee are shown in terms of x% and y%, respectively, so that they may be set at rates most suitable to the circumstances by assigning desired values to the variables x and y. The term “BC” refers to the maximum selling price of merchandise including Sch that can be purchased using all of the current balance of Cyber Credit, and is obtained through the following equation:

$$BC = \frac{CC \cdot ( 1 - \frac{x + y}{100} )}{1 - \frac{y}{100}} \qquad ( Equation 1 )$$

The relative sizes of PR, CC and BC are compared first. If PR≦BC, the credit-service fee (Sch) will be calculated through the following equation:

$$Sch = \frac{PR \cdot \frac{x}{100}}{1 - \frac{x + y}{100}} \qquad ( Equation 2 )$$

The additional amount to be received in this case will be zero.

If BC<PR<CC, the credit-service fee (Sch) will be calculated through the following equation:

$$Sch = \frac{PR \cdot \frac{x}{100}}{1 - ( \frac{x}{100} \cdot \frac{CC - PR}{CC - BC} + \frac{y}{100} )} \qquad ( Equation 3 )$$

The additional amount to be received in this case will be:

Sch+PR−CC

If CC≦PR, the credit-service fee (Sch) will be calculated through the following equation:

$$Sch = \frac{CC \cdot \frac{x}{100}}{1 - \frac{y}{100}} \qquad \{ Equation 4 )$$

The additional amount to be received in this case will be:

Sch+PR−CC

The foregoing equations are the creation of the inventors. The use of the credit-service fee calculated by these equations, and the forms of collection and payment of fees as shown in the flowcharts of FIGS. 5 through 7, simultaneously achieves the following various effects:

(1) Cyber Credit equivalent to the price of merchandise is saved on behalf of the customer. The use of the ordinary merchandise purchase allows the purchase of merchandise of an equal price to the Cyber Credit amount.

(2) The broker is able to obtain a prescribed brokerage fee according to the amount received from the customer (at y% of the received amount).

(3) The dealer whose merchandise is merely selected as a gift merchandise is able to obtain a nomination fee for profit according to the selling price of the merchandise selected (at x% of the selling price).

(4) The dealer who ultimately sells merchandise is guaranteed the amount received as prescribed by the selling price thereof (actual sales amount).

Actual sales amount:

In the purchase of merchandise for a gift:

Amount to be paid=Selling price of merchandise X (1−x/100−y/100)

In the ordinary purchase of merchandise:

Amount to be paid=Amount of credit used X (1−x/100−y/100)+Amount received X (1−y/100)

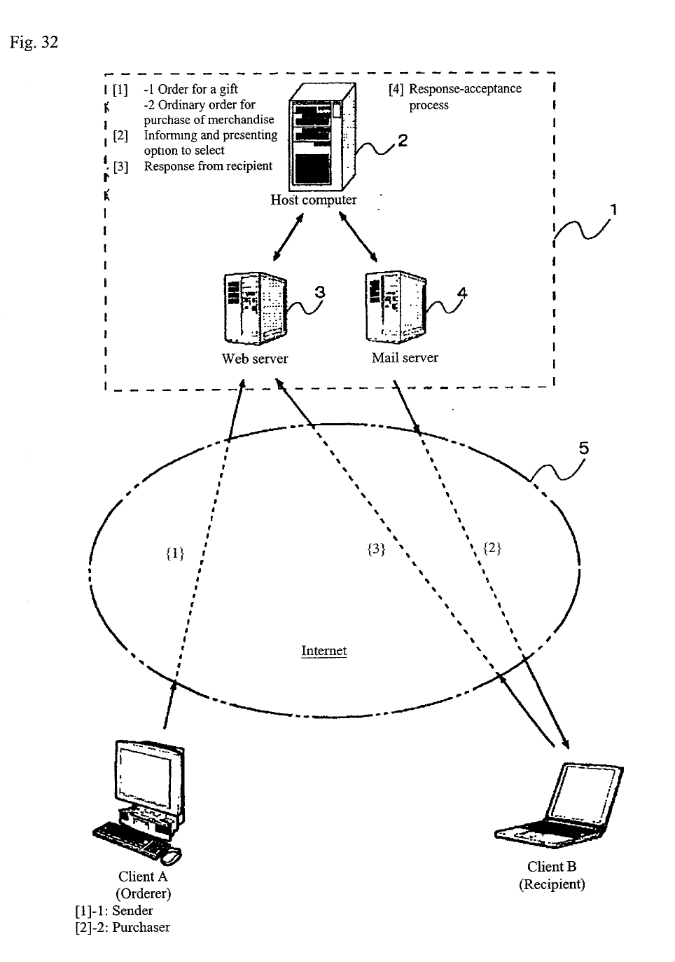

Next, the business procedure as described in the foregoing may also be implemented through the Internet. The embodiment described below uses the operating mode according to mode D in FIG. 3. FIG. 32 shows a summary configuration of the business procedure of the invention through the Internet. The embodiment shown in the figure utilizes the Internet 5 as a means of implementing the business procedure of the invention. The items marked 1 are a business operation/management apparatus for implementing various processes relative to the business procedure of the invention over the Internet, such apparatus comprising host computer 2, web server 3 and mail server 4. Various programs necessary for implementing different processes relative to the business procedure of the invention are stored in host computer 2. The main purposes of these programs are to automatically execute steps {1} through {4}, as shown also in FIG. 1.

Specifically, an order for the purchase of merchandise is first accepted through a website that is furnished by business operation/management apparatus 1 ({1}). If the order is for a gift ({1}-1), the recipient designated by the sender is informed of the order through e-mail. Simultaneously the recipient is offered choices—being to “take” the gift merchandise, “credit” the value equivalent to the selling price of the gift merchandise in lieu of taking the same, or “exchange” the gift merchandise for another desired merchandise—and is prompted to access the website furnished by business operation/management apparatus 1 ({2}). When the recipient accesses the website, the response (selection) the recipient makes out of the choices offered is accepted ({3}). Subsequently, various processes are implemented as the response-acceptance process according to the response ({4}).

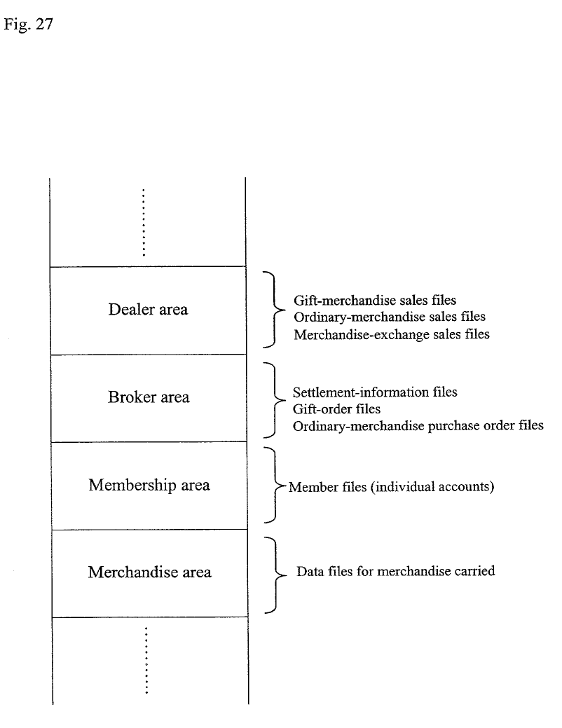

When an order for the purchase of merchandise is accepted ({1}-2), the necessary process is implemented for the delivery of the designated merchandise to the designated destination without following steps {2} through {4}. The form of “delivery” will not be specifically described as various forms may be considered, including assignment of the task to an existing delivery service. Business operation/management apparatus 1 stores various files (ledgers and the like) relative to orders as data in the memory thereof. FIG. 27 shows the contents of the different areas of memory. As shown in the figure, the dealer area, broker area, membership area and special area for merchandise files (merchandise area) are allocated within the memory. The dealer area stores (records) data equivalent to gift-merchandise sales files, ordinary-merchandise sales files and merchandise-exchange sales files. The broker area stores data equivalent to settlement information files required for brokerage fees, gift-order files showing the contents of gift orders, and merchandise-purchase order files showing the contents of ordinary merchandise purchase orders. The membership area stores data equivalent to member files (including the credit-account files of individual members). The merchandise area stores data files for the merchandise carried. Explanations of all these files follow in a sequence.

FIG. 9 is a flowchart showing a summary of the overall process by business operation/management apparatus 1. When a customer accesses the homepage through the Internet 5 in a prescribed manner, business operation/management apparatus 1 identifies what process is required by the access at step 901 and begins processing each category as required. That is, the merchandise-purchase request process at step 902 is initiated on an “ordinary merchandise purchase order,” the gift-request process at step 903 is initiated on a “gift order,” and the response-acceptance process at step 904 is initiated on a “response from recipient.”

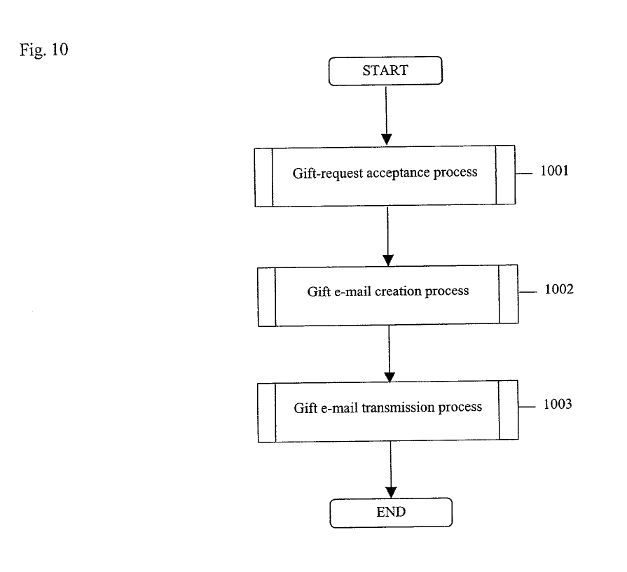

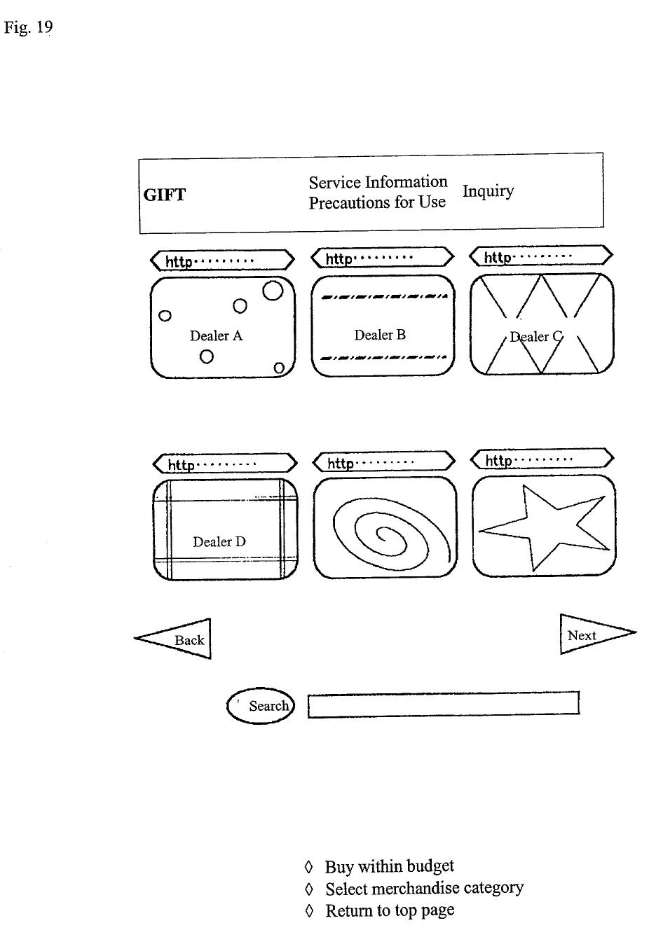

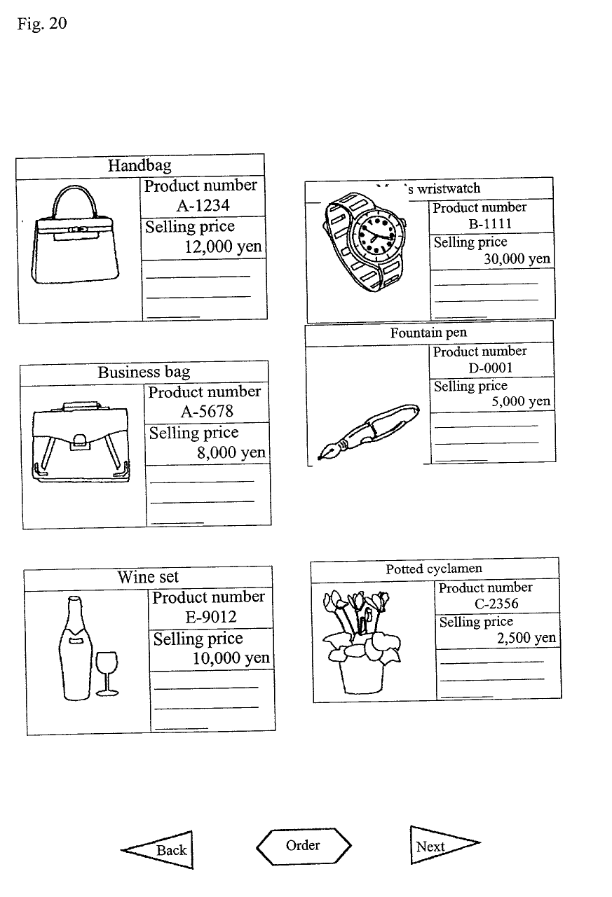

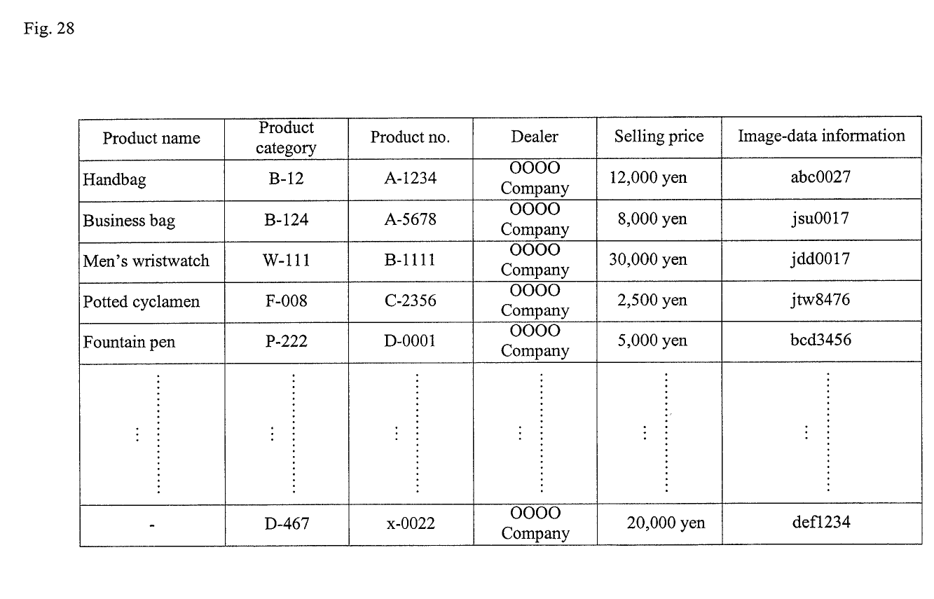

FIG. 10 is a flowchart showing a summary of the gift-request process at step 902. As the chart shows, the gift-request process includes the gift-request acceptance process at step 1001 for the sender, the gift e-mail creation process at step 1002 to provide the recipient with a description of the gift order, and the gift e-mail transmission process at step 1003 to transmit the same to the recipient. In the gift-request acceptance process at step 1001, a web page as shown in FIG. 19 is displayed. This web page shows a plurality of dealers (virtual outlet stores). The sender would select a desired dealer on the web page. Next, the merchandise carried by each dealer is presented. FIG. 20 shows an example of the web page to be displayed at the sender's end. As illustrated, this example displays the product name, product number, selling price and image-data information for each item. All such information relative to the merchandise carried is stored in the memory of business operation/management apparatus 1 as merchandise data files, as shown in FIG. 27. FIG. 28 (b) shows the contents (an example) of a merchandise data file. As illustrated, this file stores the dealer, product name, product category, product number, selling price and applicable image-data information for each item. The data configuration allows web display by merchandise category, selling price and others, in addition to display by the dealer.

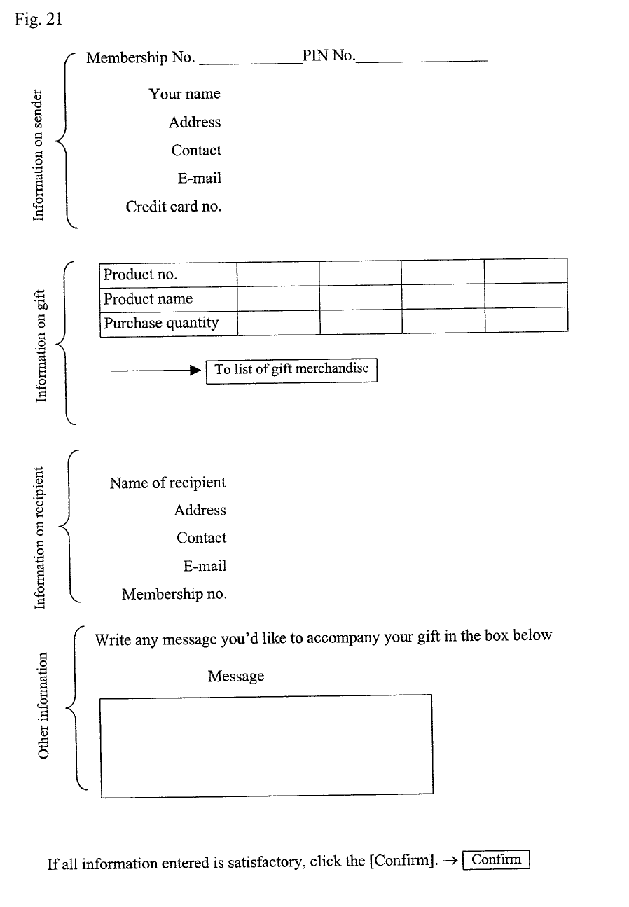

When a sender selects certain gift merchandise, the gift-order web page shown in FIG. 21 is displayed, whereby the sender enters various information required to order a gift. As shown in FIG. 21, the information entered by the sender includes information on the recipient, gift merchandise and the like, in addition to information on the sender. Examples of the information on the sender may include the sender's name, address, contact/telephone number, e-mail address, credit-card number and the like. If the sender is a member, the sender's entry of the membership number and PIN number eliminates or simplifies the entry of other information. Examples of the information on the recipient may include the recipient's name, address, contact/telephone number, e-mail address and the like. Examples of the information on gift merchandise may include the product name, product number, purchase quantity (number of pieces), selling price and the like of the merchandise. All such information on the particular merchandise that a sender may select from the web page illustrated in FIG. 20 will be retrieved from the merchandise data file, previously explained, and entered automatically. In a case where the sender selects merchandise from a merchandise catalog or the like in advance, the sender would separately enter the merchandise information on the gift-order web page. Other information may include a message from the sender to the recipient.

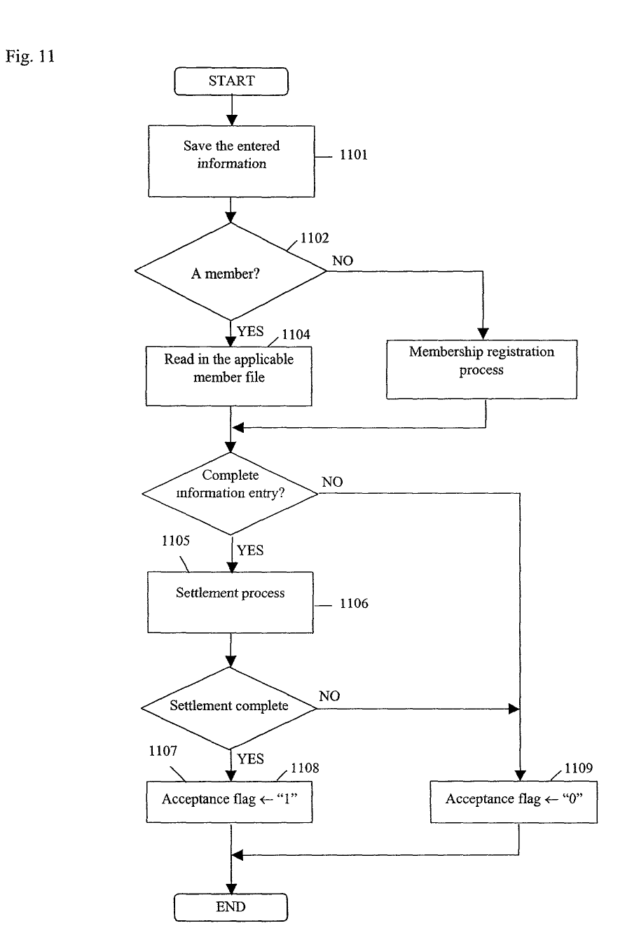

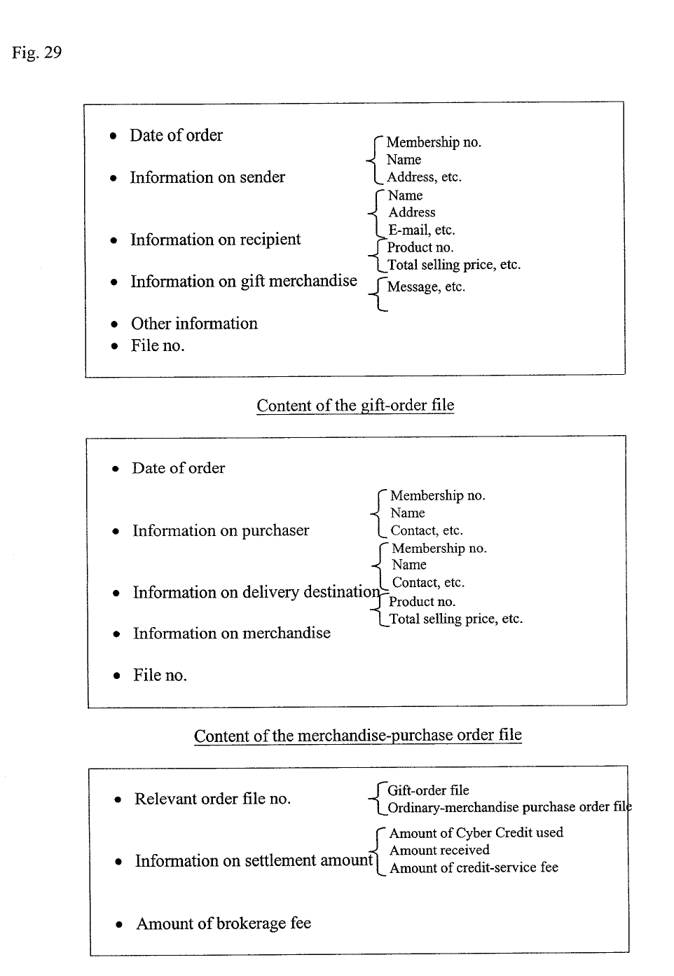

FIG. 11 is a flowchart showing the details of the gift-request acceptance process at step 1001. As illustrated, business operation/management apparatus 1 records or stores in the broker area of memory, as shown in FIG. 27, the contents of all information as a gift file for each order, as identified by the sender through the gift-order web page in FIG. 21 at step 1101. FIG. 29 (a) a shows the contents of the gift-order file. As shown in the figure, the file stores the date of order and various information, as specified by the sender, such as information on the sender, recipient, gift merchandise (including the total selling price) and the like. Additionally, a file number is assigned to each gift order (one order) such that the relationship between the subject file and other files is identified.

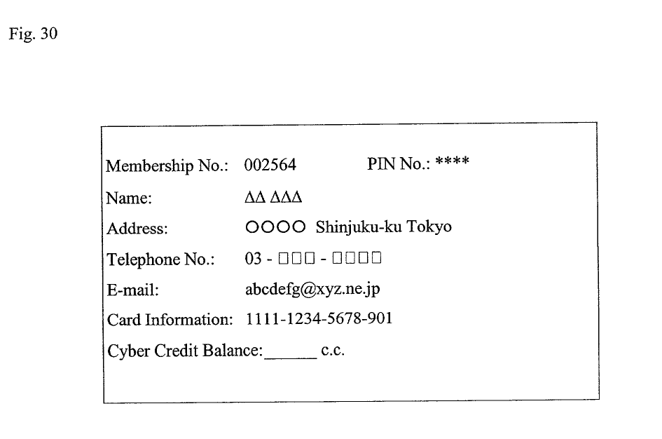

Next, the information on the orderer thus read in is checked in order to identify whether or not the user is a member at step 1102. If the orderer is not a member (step 1102, NO), the membership registration process is implemented at step 1103. In the membership registration process, personal data is stored in the membership area of memory, as shown in FIG. 27, as a member file by the customer. FIG. 30 shows the contents of member files. The member file is given the membership number of the individual customer and stores the customer's name, address, contact/telephone number, e-mail address and card information (card number). The balance of Cyber Credit for the individual member is also stored in this file (individual account). If the orderer is a member (step 1102, YES), the member's personal data, as previously described, is retrieved from the membership area (member file) and the information on the orderer is read in at step 1104. Subject to the availability of complete information required for a gift order (step 1105, YES), the settlement process is implemented at step 1106. If the input information is incomplete (step 1105, NO), the gift-order acceptance flag turns “0” at step 1109 and the gift-request acceptance process is terminated.

When the settlement process is completed (step 1107, YES), the gift-order acceptance flag is set to “1” at step 1108 and the process is terminated. If the settlement process is not completed (step 1107, NO), the gift-order acceptance flag will be set to “0” at step 1109 and the process terminated. For the procedure for the settlement process at step 1106, refer to the previous explanation of an example of implementing the business procedure (FIGS. 5 through 7). In this example the payment is made through the use of a credit card (for convenience, hereinafter called a “card”). As is widely known, settlement through the use of a card involves an inquiry made to an authentication server and the like for granting a credit line and verifying the card based on the card number, cardholder's name, PIN number and other information.

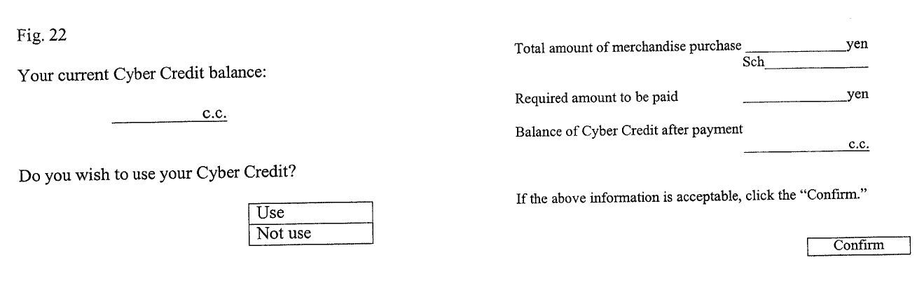

FIG. 22 shows an example of the web page to be displayed at the sender's end during the settlement process at step 1106. As illustrated, the total amount of the merchandise purchase is calculated from the member file and displayed on the web page for each order. If the orderer is a member, the orderer's credit balance is retrieved and displayed. The orderer is then asked whether to use Cyber Credit, and on the selection of the “use” the credit-service fee (Sch) is calculated using the equation shown in FIG. 8 and displayed. If the credit balance is insufficient, the additionally required payment is calculated and displayed. Upon the completion of these processes, the credit amount used is deducted from the member file, whereupon the balance is displayed on the web page and saved in the member file as the new credit balance. In the settlement process at step 1106, various information relative to the settlement is also saved in the form of data files (ledgers), as previously described.

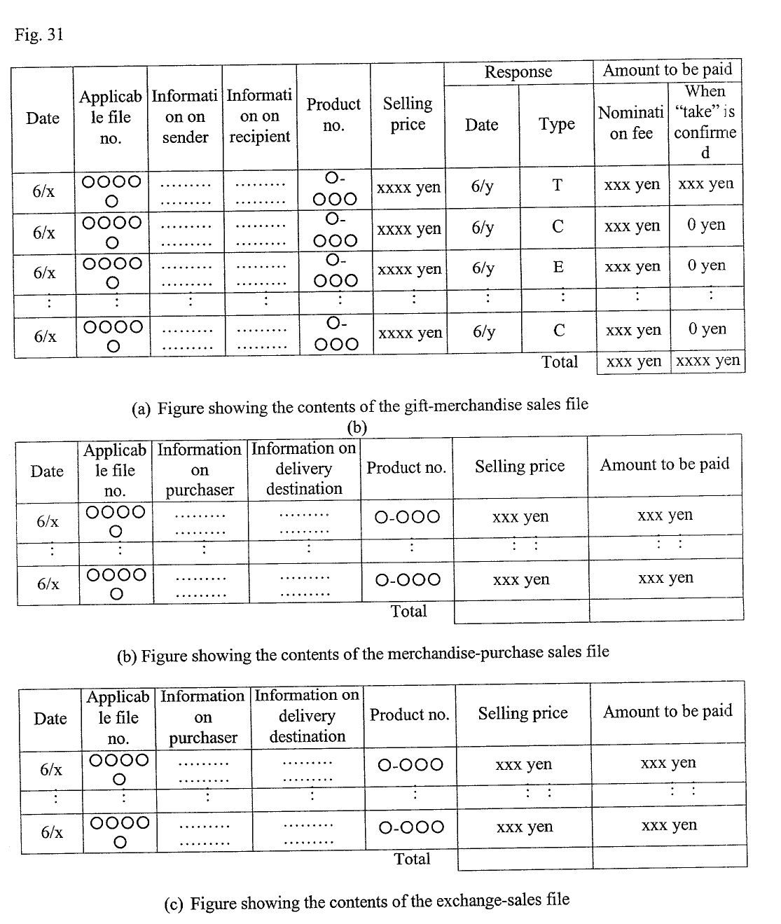

FIG. 31(a) shows the contents of the gift-sales file. In writing to the gift-sales file, reference is made to the information previously stored in the gift-order file in step 1101. The gift-sales file is stored for each dealer in the dealer area, as shown in FIG. 27. As shown in FIG. 31(a), the gift-sales file stores various information for identifying the merchandise for each gift merchandise, including the date of order and information on the sender and recipient (membership number, product number and the like), as well as the selling price of the gift merchandise. A file number is also given to the file at this time in order to allow identification of the applicable gift-order file and relationship with other files. When the recipient responds, the type of response (the “take,” “exchange” or “credit”) is also stored here. Also stored is the amount of the fee to be paid to the dealer, and also the balance payable upon the confirmed selection of “take.” The total amount of the nomination fee and amounts payable upon the confirmed selection of “take” is calculated, for instance, by the month. The nomination fee is posted upon the confirmed completion of settlement in step 1107, in the amount calculated using the equation shown in step 506 in FIG. 5.

FIG. 29 (c) shows an example of the contents of the settlement-information file stored as data during the settlement process at step 1106. This file is saved in the broker area of memory, as shown in FIG. 27. As illustrated, the gift-sales file stores, for each gift merchandise, the date of order, a file number identifying the relationship with the gift-order file (or the ordinary-merchandise purchase order file) and the settlement information consisting of the amount of Cyber Credit used, amount received and credit-service fee (Sch). The brokerage fee, which would be the broker's profit, is calculated out of the amount received (y% of the received amount) and recorded. The total amount of settlement (namely, the amount of credit used, amount received and credit-service fee) and the brokerage fee is to be calculated, for instance, by the month. In this example the file also simultaneously stores settlement information relative to the ordinary orders, for which details are to be given later.

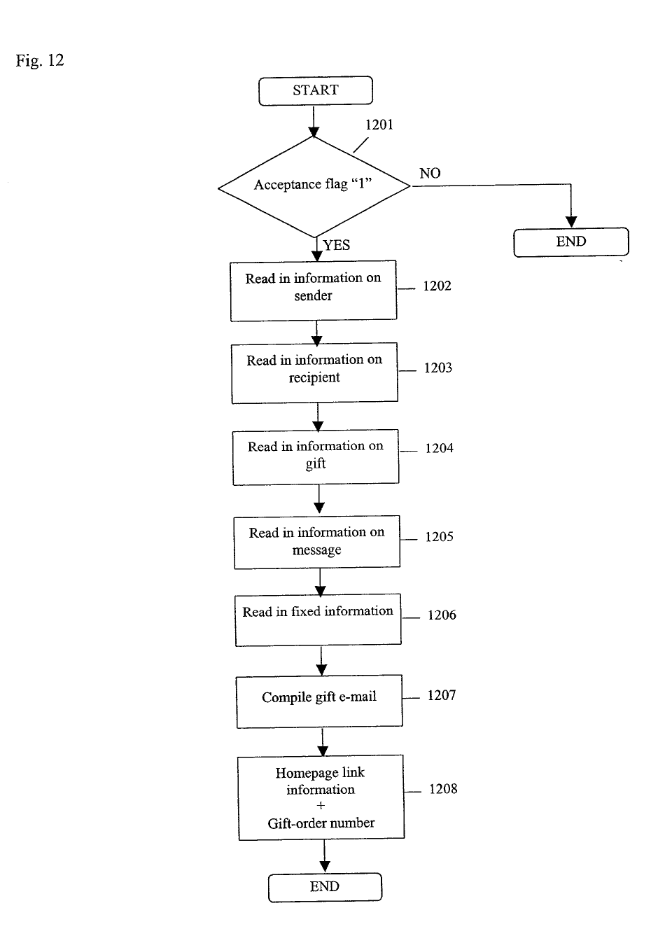

Next, the details of the gift e-mail creation process, identified as step 1002, are shown in the flowchart of FIG. 12. In the gift e-mail creation process, only if the gift-order acceptance flag is set at “1” (step 1201, YES), various information (on the sender, recipient, gift and message) of the order file, stored in step 1101, and the fixed information for the e-mail is read in at steps 1202 through 1206. Next, gift e-mail is compiled according to a prescribed format based on the information thus read in at step 1207. The URL is added to allow the recipient to link to the homepage at step 1208. Also added is a “gift-order number,” which actually is the applicable gift-order file number or the like (or any other number that identifies the same) such that the identification of the information relative to the recipient is facilitated when a response is received from the recipient at step 1208.

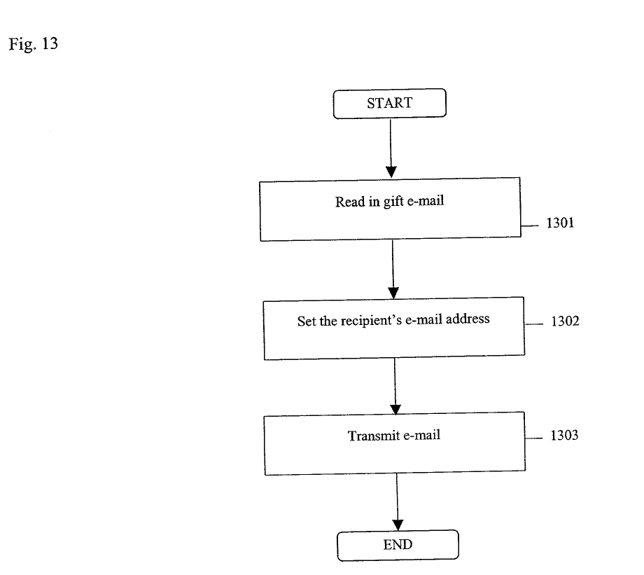

The flowchart of FIG. 13 shows the details of the gift e-mail transmission process at step 1003. First, as illustrated, in the gift e-mail transmission process the gift e-mail, as previously generated in step 1002, is read in at step 1301. Next, the recipient's e-mail address is set up as an address to which the e-mail is delivered at step 1302, and the e-mail is transmitted at step 1303. The e-mail is transmitted through mail server 4, shown in FIG. 1. The recipient subsequently receives the e-mail through a prescribed protocol.

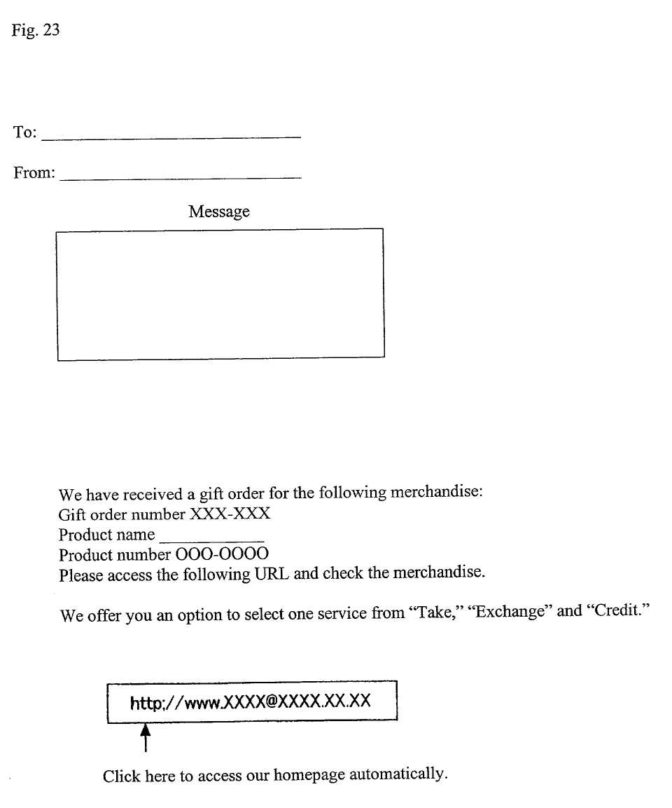

An example of the gift e-mail that would be displayed at the recipient's end is illustrated in FIG. 23. As the figure shows, the gift e-mail contains various information—including information on the sender and gift merchandise—that allows the recipient to know who has ordered what merchandise as a gift for the recipient. The e-mail gives instructions that prompt the recipient to access the homepage and select a desired service from “take,” “exchange” and “credit.” The gift e-mail contains a gift-order number and a hyperlink URL to the homepage.

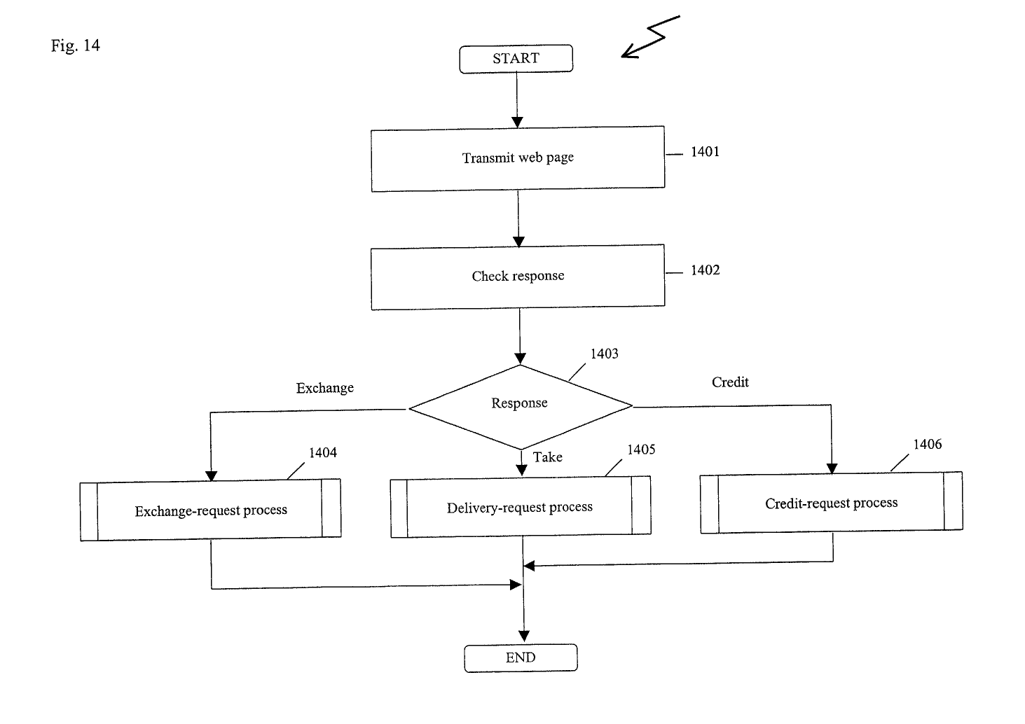

When the gift recipient who receives the gift e-mail follows the instructions therein and accesses the home page, a process—shown as the response-acceptance process at step 904 in the flowchart of FIG. 14—is implemented by business operation/management apparatus 1.

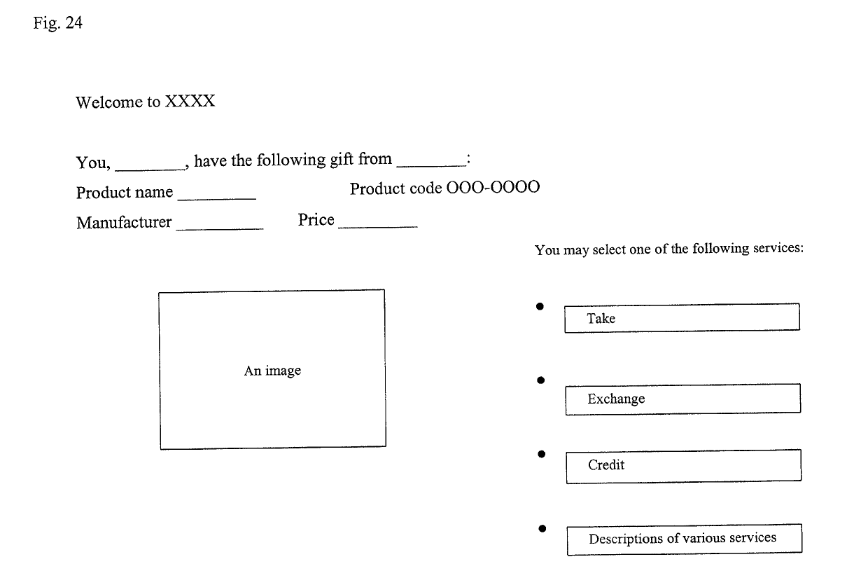

In the response-acceptance process a prescribed web page is transmitted to the recipient's side at step 1401. An example of the web page is given in FIG. 24. As shown, an image of the merchandise is displayed together with the name and manufacturer of the merchandise and other information, thereby allowing the recipient to know the details of the gift merchandise. Although not shown in the flowchart, when the web page is transmitted the recipient may enter the order number, attached to the e-mail, and thereby retrieve a relevant file (gift-order file, for instance) from a memory area in FIG. 27 to identify the information and the like concerning the gift. When the recipient selects or returns any one of “take,” “exchange” and “credit” on the web page, gift business processing apparatus 1 checks the contents of the response at step 1402. If the selection or response of the recipient is the “take” at step 1403, the delivery-request process at step 1405 for the gift merchandise is implemented. If the “exchange” at step 1403, is selected for desired merchandise, the exchange-request process at step 1404 is implemented. And if the “credit” at step 1403, is used, the credit-request process at step 1406 is implemented.

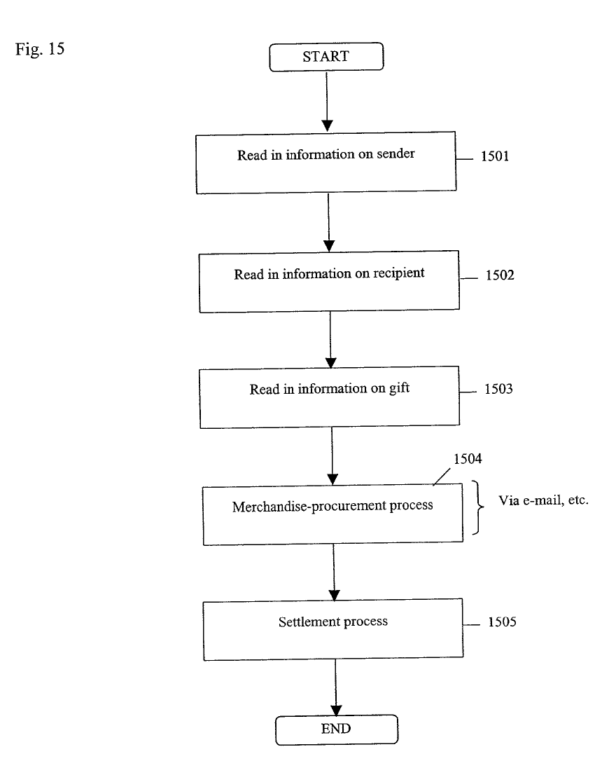

The details of the delivery-request process at step 1405 are shown in the flowchart of FIG. 15. As shown in the figure, in the delivery-request process the information on the sender, recipient and gift merchandise is read in sequentially from the gift-order file at steps 1501 through 1503. Next, the merchandise-procurement process is implemented at step 1504. In the merchandise-procurement process (step 1504) various information read in through steps 1501 through 1503 is transmitted via e-mail to the dealer of the merchandise designated as a gift in order to arrange the delivery of the designated merchandise to the address of the recipient. Although the merchandise-procurement process in this instance is implemented via e-mail, various other forms of communication may be used.

When the merchandise-procurement process at step 1504 is completed, the settlement process is implemented at step 1505 based on the confirmed selection of “take” for the gift merchandise. Here symbol “T,” for instance, is stored in the response column of the applicable gift-merchandise sales file shown in FIG. 31 (a), indicating that “take” has been confirmed. Next, the balance payable to the dealer is calculated using the equation shown in step 603 in FIG. 6, and is stored or posted in the applicable column.

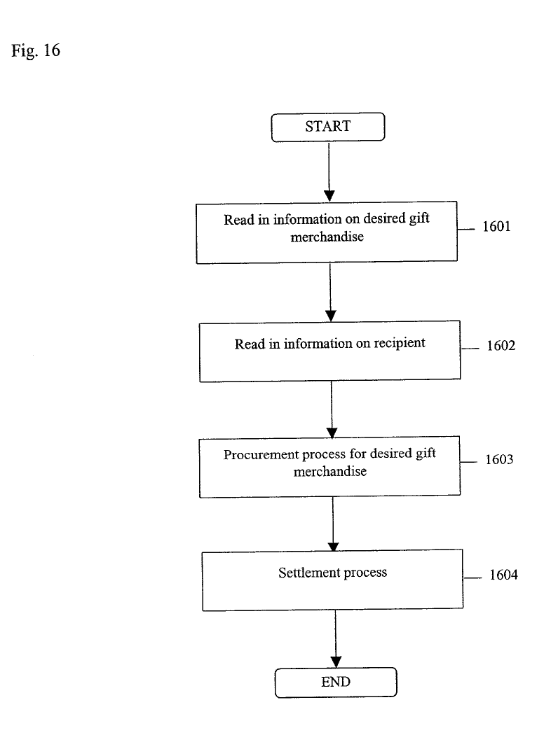

The details of the exchange-request process are shown in the flowchart of FIG. 16. As illustrated, in the exchange-request process the information on the desired gift merchandise if designated by the recipient is read in at step 1601. The desired merchandise here refers to merchandise newly designated by the recipient upon selecting an “exchange” to replace the sender-designated merchandise. Although not shown in the flowchart, in the process of exchanging merchandise business operation/management apparatus 1 refers to the merchandise data file stored in the memory area and automatically selects merchandise equivalent to the selling price of the merchandise or the total selling price of a group of merchandise, as originally designated by the sender. The selected merchandise group is displayed on the web page as exchangeable merchandise, together with the image data, whereupon the recipient selects the desired merchandise from the web page. This identifies or reads in the information on the desired merchandise.

In step 1602 the recipient's name, address and other information is read in from the gift-order file at step 1602. The recipient may be required to enter current information on the web page to allow for a possible change in address and other information. In step 1603 that follows, the merchandise-procurement process is initiated for merchandise that the recipient has newly designated through the “exchange” service at step 1603. This process is identical to the process implemented in the delivery-request process at step 1504. In step 1604 the settlement process is implemented based on the confirmed selection of “exchange” for the gift merchandise. Here symbol “E,” for instance, is stored in the response column of the applicable gift-merchandise sales file, indicating that the “exchange” has been confirmed. An amount of “0” (0 yen) is stored as the balance payable to the sender-designated dealer. Next, the information on the gift merchandise newly designated by the recipient is stored as the exchange sales file. This exchange sales file will be stored as data in the dealer area shown in FIG. 27. The contents of the exchange sales file are shown in FIG. 31 (c). An exchange sales file is created for each dealer and stores the file number of the applicable gift-order file (or a number that allows identification of the relationship with the gift-order file), information on the recipient, product number and selling price. This exchange sales file also stores the amount payable to the dealer of the merchandise newly designated by the recipient, the amount of which is calculated using the equation shown in step 603 in FIG. 6.

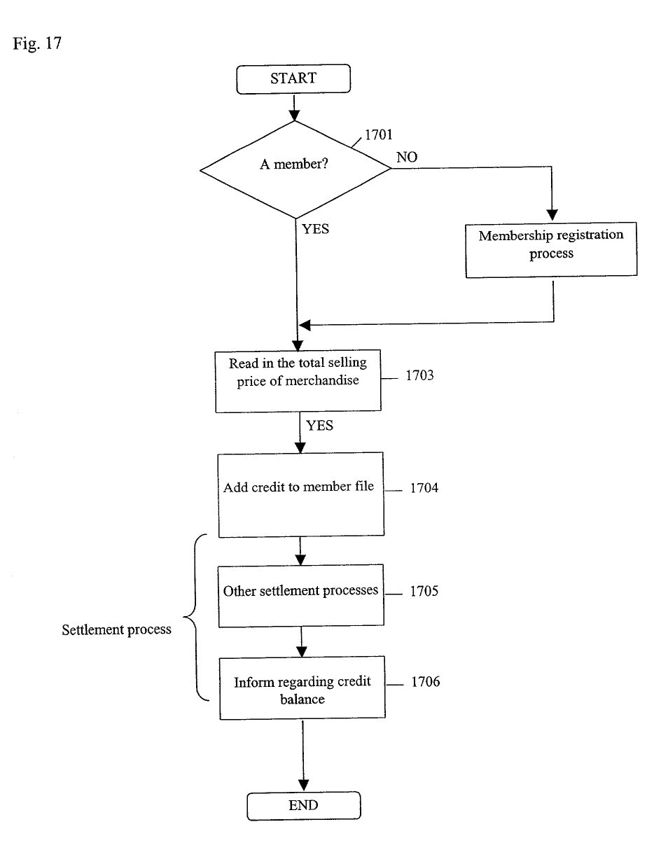

The flowchart of FIG. 17 shows the credit-request process. In the credit-request process the recipient is checked to determine whether or not the recipient is a member at step 1701. The reason for the checking is that the credit amount calculated on the basis of the selling price of the gift merchandise needs to be stored in the member file at the time the credit is stored. If the recipient is not a member (step 1701, NO), the membership registration is processed through a prescribed procedure at step 1702, and the member file for the user is created. If the recipient is already registered (step 1701, YES), the membership registration process will be omitted. In step 1703 the total selling price of the sender-designated merchandise is read in from the applicable gift-order file at step 1703, and an equal amount of Cyber Credit is added to the credit-management file for that particular member at step 1704. In step 1705 the symbol “C,” for instance, is stored in the response column of the applicable gift-merchandise sales file, indicating that the “credit” has been confirmed. An amount of “0” (0 yen) is stored as the balance payable to the sender-designated dealer. Steps 1704 and 1705 are equivlent to the settlement process 2 at step 211 shown in FIG. 2. In step 1706 a new Cyber Credit balance for the recipient is displayed on the web page at step 1706. A description of this web page is omitted.

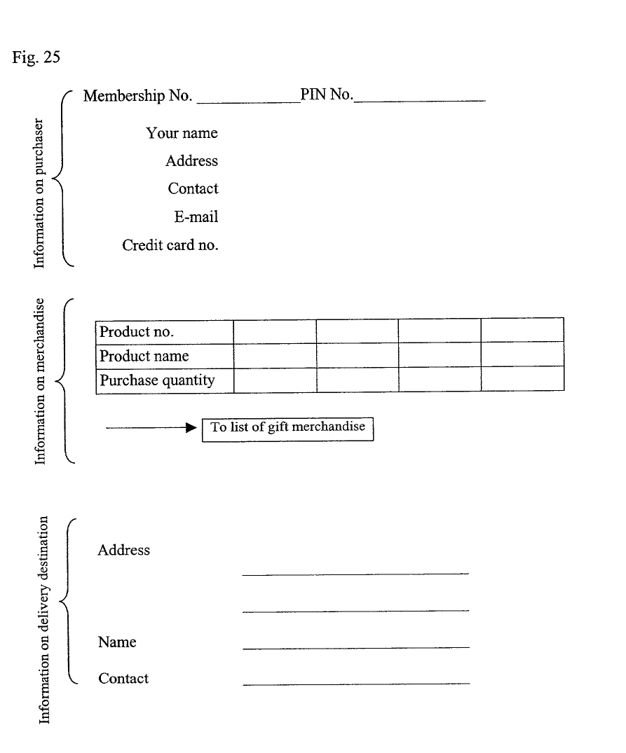

The following describes the merchandise-purchase request process (shown as step 202 in FIG. 9). And explanation for the selection of merchandise is omitted because it is almost identical to the form used in the previously explained process of gift order. In the merchandise-purchase request process the purchaser (shown as client A in FIG. 1) enters various required information on the web page for merchandise-purchases order, shown in FIG. 25. As shown in the figure, the entered information includes information on the purchaser, merchandise to be purchased and delivery destination. Examples of the information on the purchaser may include the purchaser's name, address, contact/telephone number, e-mail address and credit card number used for settlement. If the purchaser is a member, the simple entry of the membership number and PIN number may eliminate or simplify the entry of information for the purchaser. Examples of the information on the merchandise to be purchased may include the product name, product number, quantity (number of pieces), selling price and the like regarding the merchandise to be purchased. All such information on the particular merchandise that a sender may select from the web page will be retrieved from the merchandise data file, previously explained, and entered automatically. In a case where the sender selects merchandise from a merchandise catalog or the like in advance, the sender would separately enter the merchandise information on the gift-order web page. As for the “information on the delivery destination,” if the destination of merchandise delivery differs from the address of the purchaser (orderer), the address of the destination is additionally specified.

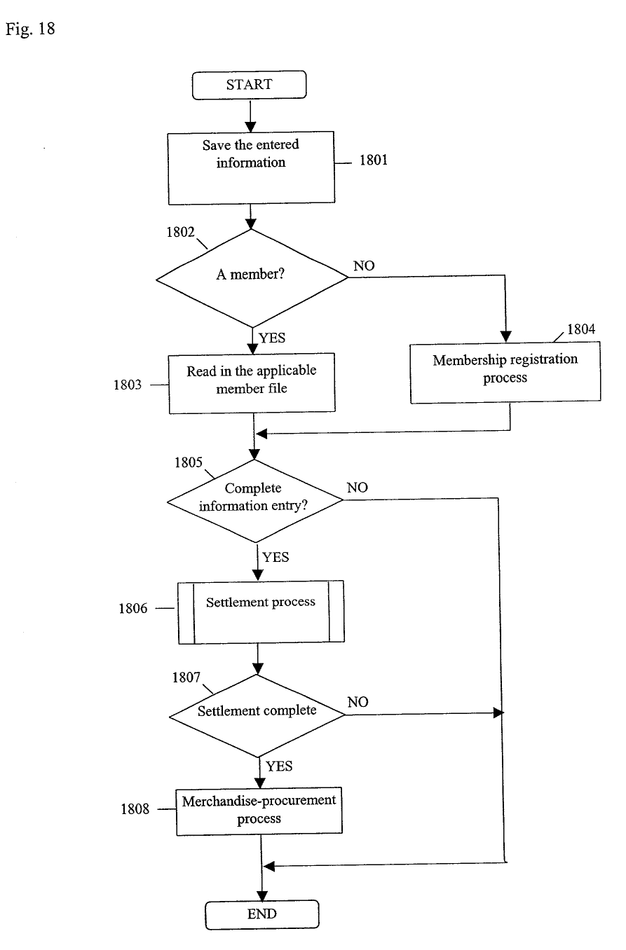

The details of the merchandise-purchase request process are shown in the flowchart of FIG. 18. As illustrated, business operation/management apparatus 1 stores various information, as identified by the purchaser as explained previously, in the ordinary-merchandise purchase order file at step 1801. The contents of the ordinary-merchandise purchase order file are stored for each order in the broker area of memory, as shown in FIG. 27. FIG. 29 (b) shows the contents of the order file. As shown in the figure, the file stores the date of order and various information, as specified by the purchaser, such as information on the purchaser, delivery destination, merchandise (including the selling price, total selling price and the like) and the like. Additionally, a file number is assigned to each order such that the relationship between the subject file and other files is identified. In step 1802 the purchaser is checked as to whether or not he or she is a member. If the purchaser is not a member (step 1802, NO), the membership registration is processed through a prescribed procedure at step 1804. If the purchaser is a member (step 1802, YES), the member's personal data is retrieved from the membership area ir member file at step 1803 in order to identify the member's information.

Next, subject to the availability of complete information required for an ordinary merchandise purchase (step 1805, YES), the settlement process is implemented at step 1806. If the input information is incomplete (step 1805, NO), the merchandise-purchase request process is terminated. When the settlement process is completed at step 1806, the merchandise-procurement process is implemented at step 1808 next, subject to the completion of the settlement (step 1807, YES). If the settlement is not completed (step 1807, NO), the merchandise-purchase request process is terminated.

For the procedure for the settlement process at step 1806, refer to the previous detailed explanation (FIG. 7). In an ordinary merchandise purchase payment may also be made through the use of a credit card (for convenience, hereinafter called a “card”). The process of settlement through a card is identical to that previously described for a “gift order.”

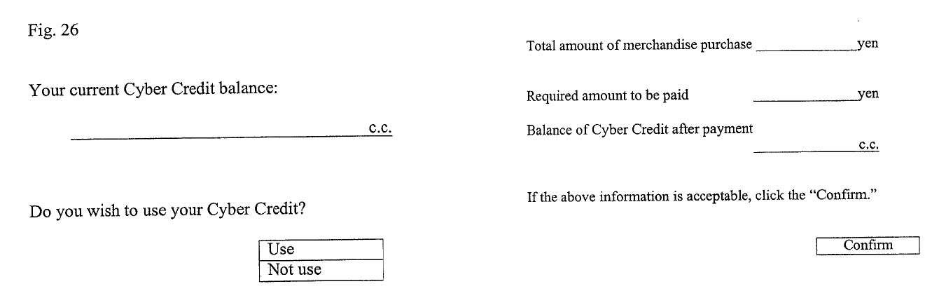

FIG. 26 shows an example of the web page to be displayed at the purchaser's end during the settlement process at step 1806. As illustrated, the “Sch” is not displayed since no credit-service fee is collected in ordinary merchandise purchases. On the web page the total amount of the merchandise purchase is displayed. If the purchaser is a member, the orderer's credit balance is retrieved from the member file and displayed. The purchaser is then asked whether to use Cyber Credit. If the “use” is selected but the Cyber Credit balance of the orderer is below the selling price of the desired merchandise, the difference will be calculated and displayed as the amount to be paid. Upon the completion of these processes, the credit amount used is deducted from the member file, whereupon the balance (the Cyber Credit balance after payment) is displayed on the web page and saved in the member file of the purchaser as the new credit balance. In the settlement process, various information relative to the settlement is also saved in the form of files (ledgers), as previously described.

FIG. 31 (b) shows an example of the contents of the ordinary-merchandise purchase sales file that is stored as data during the settlement process. The information in the merchandise-purchase order file stored in step 1801 is read out at that time. The merchandise-purchase sales file is stored for each dealer in the dealer area, as shown in FIG. 27. As shown in FIG. 29 (b), the merchandise-purchase sales file stores various information for identifying the merchandise for each merchandise purchased, including the date of order and information on the purchaser and delivery destination (membership number, product number and the like), as well as the selling price of the merchandise. A file number is also given to the file at this time to allow identification of the relationship with the merchandise purchase-order file. Also in the settlement process the date of order, a file number identifying the relationship with the merchandise purchase-order file and the settlement information consisting of the amount of credit used and amount received are stored in the settlement-information file (FIG. 29 (c)), as previously described, for each merchandise purchase order.

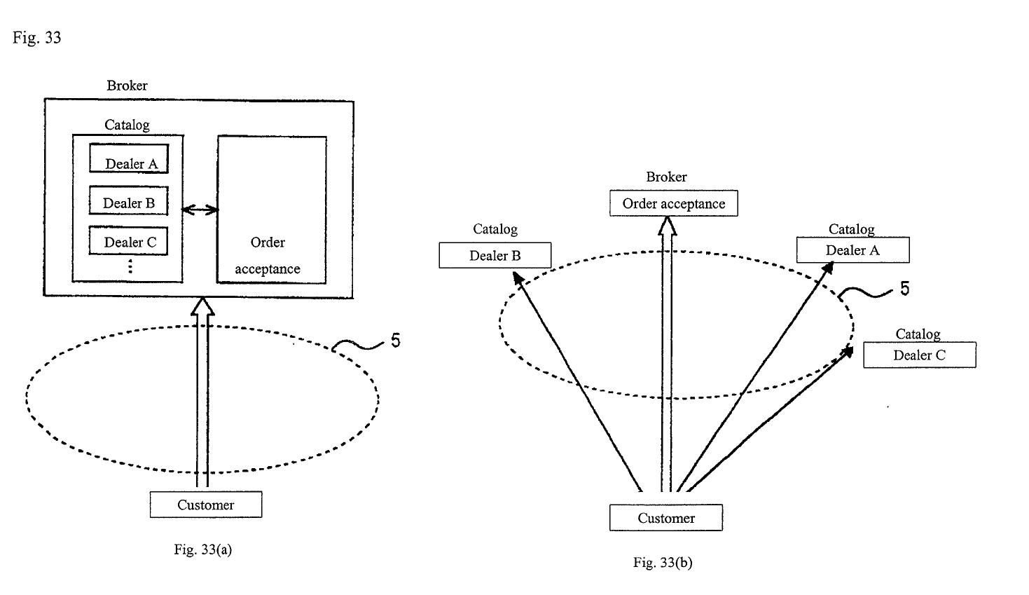

FIG. 33 shows the concept of the links that may be provided between the customer and the broker and/or dealer on the Internet 5. The form of embodiment, as explained previously, accepts an order and presents the merchandise to be purchased (catalogs A, B, C, . . . ), allowing the customer to select merchandise on the same website, as shown in FIG. 33 (a). The embodiment may also allow the merchandise presentation to the customer and the merchandise selection by the customer at a separate site for each dealer as the second form of embodiment. The mode of linkage between the customer and the broker/dealers in that form is shown in FIG. 33 (b). In that example, as shown in the figure, the presentation of the merchandise to be purchased (catalogs A, B, C, . . . ) and the selection of merchandise by the customer is carried out at the site of each dealer. On the other hand, the various procedures before and after the selection of merchandise are carried out at the broker's site. The link between the sites in this instance would be easily implemented by, for example, the dealer and broker attaching a homepage URL to their web pages. In this example the dealer's homepage URL for a particular item of merchandise may be attached to the e-mail transmitted to the gift recipient. In the form of the embodiments shown previously, the choices given to the recipient are “take,” “exchange” and “credit,” but, obviously additional choices may be added. One such example would be “refused.” In this instance the deposit of Cyber Credit corresponding to the sender-designated 4 merchandise to the sender's individual account would facilitate action for response without the need to process a refund to the sender.

As is evident in the foregoing explanation, the use of the business procedure in this invention enables the offering of a business procedure and gift business operation/management apparatus that facilitate flexible response to the wishes of the gift recipient while respecting the sender's original intent. The broker is able to establish itself as an independent business entity by collecting a prescribed fee from the dealer without adding any burden to the merchandise purchaser. The payment of a prescribed nomination fee to the dealer of the merchandise originally designated by the sender urges merchandise dealers to participate in the business procedure, thereby leading to the proliferation of the business procedure.

What is claimed is:

1. A method of purchasing merchandise for a recipient, comprising:
a step of accepting an order either for a simple purchase and delivery of merchandise, for the purchase of merchandise as a gift not accompanied by an option to select, or for a purchase and delivery of merchandise as a gift accompanied by an option to select;
a step of making an unconditional delivery upon acceptance of an order either for the simple purchase and delivery of merchandise or for the purchase and delivery of merchandise as a gift not accompanied by an option to select, in which the necessary arrangements are made for the unconditional delivery of the merchandise, as designated by the orderer, without granting the recipient an option to select;
a step of granting the recipient an option to select upon acceptance of an order for the purchase and delivery of merchandise as a gift accompanied by an option to select, in which the designated recipient is informed of a content of the gift and is granted an option of selecting from a set of choices, including “take” and “credit”; and
a step of responding to a selection by the recipient, whereby if the recipient selects the “take,” the necessary arrangements are made to deliver to the recipient the merchandise designated by the orderer as a gift; or if the recipient selects the “credit,” a credit is posted to the account of the recipient, in accordance with the price of the merchandise designated by the orderer as a gift; and
wherein the credit posted to the account of the recipient may be applied to all or part of the amount of an order, either for the simple purchase and delivery of merchandise or for the purchase and delivery of merchandise as a gift not accompanied by an option to select.

2. The method according to claim 1, wherein the credit posted to the account of the recipient may also be applied to all or part of the amount of an order for the purchase and delivery of merchandise as a gift accompanied by an option to select.

3. A method of purchasing merchandise for a recipient, comprising:
a step of accepting an order for a purchase and delivery of merchandise as a gift accompanied by an option to select;
a step of granting a recipient an option to select upon acceptance of an order for the purchase and delivery of merchandise as a gift accompanied by an option to select, in which the designated recipient is informed of a content of the gift and is granted an option of selecting from a set of choices, including “take” and “credit”; and
a step of responding to a selection by the recipient, whereby if the recipient selects the “take,” the necessary arrangements are made to deliver to the recipient the merchandise designated by the orderer as a gift; or if the recipient selects the “credit,” a credit is posted to the account of the recipient in accordance with the price of the merchandise designated by the orderer as a gift; and
wherein the credit posted to the account of the recipient may be applied to all or part of the amount of an order for the purchase and delivery of merchandise as a gift accompanied by an option to select.

4. A method of purchasing merchandise for a recipient, comprising:
a step of accepting an order for a purchase and delivery of merchandise as a gift accompanied by an option to select;
a step of granting a recipient an option to select upon acceptance of an order for the purchase and delivery of merchandise as a gift accompanied by an option to select, in which the designated recipient is informed of a content of the gift and is granted an option of selecting from a set of choices, including “take” and “exchange”; and
a step of responding to a selection by the recipient, whereby if the recipient selects the “take,” the necessary arrangements are made to deliver to the recipient the merchandise designated by the orderer as a gift; or if the recipient selects the “exchange,” the merchandise designated as a gift by the orderer is replaced by the merchandise designated by the recipient and the necessary arrangements are made for the delivery thereof to the recipient.

5. The method according to any of claims 1 through 3, wherein a nomination fee, according to a price of a scheduled sale, is paid to a potential dealer of the merchandise originally scheduled for purchase as a gift but not actually purchased because the recipient selects “credit.”

6. The method according to any of claims 1 through 3, which is implemented by a broker who operates between the customer and one or a plurality of merchandise dealers.

7. The method according to claim 5, wherein the reduction in the actual credit amount due to the payment of the nomination fee to the potential dealer is adjusted by charging a credit-service fee such that the actual credit amount matches the apparent credit amount.

8. The method according to claims 1 through 3, wherein:
upon acceptance of an order for a gift accompanied by an option to select, the broker is paid cash and/or credit at the purchase price of the gift;
a certain amount in accordance with the cash paid by the orderer is allocated to the fee for the broker, whether or not the recipient selects “credit”;
upon selection of “credit” by the recipient, a certain amount in accordance with the purchase price of the gift is allocated to the fee for the dealer who has lost the opportunity to sell the gift; and the purchase price of the gift is posted as a credit to the account of the recipient;
when the recipient uses the credit thereof to order a new gift accompanied by an option to select, the recipient is charged a fee, either in credit or cash, in accordance with the amount of credit used;
thereby adjusting the difference between the amount of credit owned by the recipient and the amount of cash deposited with the broker by reducing the amount of credit or collecting cash.

9. A business operation/management apparatus, comprising:
a means of accepting an order through Internet for a simple purchase and delivery of merchandise, for a purchase of merchandise as a gift not accompanied by an option to select, or for a purchase and delivery of merchandise as a gift accompanied by an option to select;
a means of making an unconditional delivery upon acceptance of an order, either for the simple purchase and delivery of merchandise or for the purchase and delivery of merchandise as a gift not accompanied by an option to select, in which the necessary data is processed to deliver to a recipient the merchandise, as designated by the orderer, without granting the recipient an option to select;
a means of informing the recipient of a content of the gift, upon acceptance of an order for the purchase and delivery of merchandise as a gift accompanied by an option to select, in which the recipient is informed, through Internet, of the contents of the gift as originally ordered;
a means of querying the selection, whereby the intent of the recipient relative to the offer of the gift is queried through the Internet, in the form of giving to the recipient a choice between the “take” and “credit” relative to the gift as originally offered; and
a means of responding to and processing a selection, where upon selection of “take” by the recipient, the necessary data is processed to deliver the merchandise designated as a gift by the orderer; or upon selection of “credit” by the recipient, the necessary data is processed to post a credit to the account of the recipient according to the price of the merchandise designated as a gift by the orderer; and
wherein a credit posted to the account of the recipient may be applied to all or part of the amount of an order, either for the simple purchase and delivery of merchandise or for the purchase and delivery of merchandise as a gift not accompanied by an option to select.

10. The apparatus according to claim 9, wherein the credit posted to the account of the recipient may also be applied to all or part of the amount of an order for the purchase and delivery of merchandise as a gift accompanied by an option to select.

11. A business operation/management apparatus, comprising:
a means of accepting orders through Internet for purchase and delivery of certain merchandise as a gift accompanied by an option to select;
a means of informing a recipient of contents of the gift, where upon receipt of an order for the purchase and delivery of merchandise as a gift accompanied by an option to select, the recipient is informed, through the Internet, of the contents of the gift as originally ordered;
a means of querying the selection, whereby the intent of the recipient relative to the gift as originally offered is queried, through the Internet, in the form of giving the recipient a choice between “take” and “credit”; and
a means of responding to and processing a selection, where upon selection of “take” by the recipient the necessary data is processed to deliver the merchandise designated as a gift by the orderer; or upon selection of “credit” by the recipient the necessary data is processed to post a credit to the account of the orderer in accordance with the price of the gift designated by the orderer; and
wherein the credit posted to the account of the recipient may be applied to all or part of the amount of an order for the purchase and delivery of merchandise as a gift accompanied by an option to select.

12. A business operation/management apparatus, comprising:
a means of accepting orders whereby an order is accepted through Internet for purchase and delivery of certain merchandise as a gift accompanied by an option to select;
a means of informing a recipient of contents of the gift, where upon receipt of an order for the purchase and delivery of certain merchandise as a gift accompanied by an option to select the recipient of the gift is informed, through the Internet, of the contents of the gift as originally ordered;
a means of querying the selection, whereby intent of the recipient relative to the gift as originally offered is queried, through the Internet, in the form of giving the recipient a choice between “take” and “exchange”; and
a means of responding to and processing a selection, where upon selection of “take” by the recipient the necessary data is processed to deliver the merchandise designated as a gift by the orderer; or upon selection of “exchange” by the recipient the necessary data is processed to post a credit to the account of the orderer in accordance with the price of the gift designated by the orderer.

13. The business operation/management apparatus described in any of claims 9 through 12, wherein a means of accepting an order accepts an order via a website on the Internet.

14. The business operation/management apparatus described in claim 13, wherein a website for accepting an order for a gift includes at least one virtual outlet store.

15. The business operation/management apparatus described in claim 13, wherein a website for accepting an order for a gift is linked to at least one website on the Internet for a sale of merchandise.

16. The business operation/management apparatus described in any of claims 9 through 12, wherein a means of informing the contents of a gift is intended to inform the recipient of the gift though the sending of e-mail containing information on links to the website of a virtual outlet store selling gift merchandise.
